(19) United States
(12) Patent Application Publication
(10) Pub. No.: US 2023/0239897 A1
(43) Pub. Date: Jul. 27, 2023

(54) METHOD AND APPARATUS FOR BEAM INDICATION

(71) Applicant: Samsung Electronics Co., Ltd., Suwon-si (KR)

(72) Inventors: Dalin Zhu, Richardson, TX (US); Emad N. Farag, Flanders, NJ (US); Eko Onggosanusi, Coppell, TX (US)

(21) Appl. No.: 18/155,025

(22) Filed: Jan. 16, 2023

Related U.S. Application Data
(60) Provisional application No. 63/303,793, filed on Jan. 27, 2022.
(60) Provisional application No. 63/304,351, filed on Jan. 28, 2022.

(51) Int. Cl. H04W 72/232; H04L 1/1809; H04L 5/00

(52) U.S. Cl. CPC H04W 72/232; H04L 1/1809; H04L 5/0053

(57) ABSTRACT

Methods and apparatuses for beam indication in a wireless communication system. A method for operating a user equipment (UE) includes receiving, in a beam indication downlink control information (DCI), a plurality of transmission configuration indication (TCI) states and receiving information related to a reference TCI state from among the plurality of TCI states. The method further includes identifying, based on the information, the reference TCI state from among the plurality of TCI states; determining whether the reference TCI state is updated in the beam indication DCI; and determining, based on whether the reference TCI state was updated in the beam indication DCI, whether to transmit hybrid automatic repeat request acknowledgement (HARQ-ACK) information.

### CROSS-REFERENCE TO RELATED APPLICATIONS AND CLAIM OF PRIORITY

The present application claims priority to U.S. Provisional Patent Application No. 63/303,793, filed on Jan. 27, 2022, and U.S. Provisional Patent Application No. 63/304,351, filed on Jan. 28, 2022. The contents of the above-identified patent documents are incorporated herein by reference.

### TECHNICAL FIELD

The present disclosure relates generally to wireless communication systems and, more specifically, the present disclosure relates to a beam indication in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a beam indication in a wireless communication system.

In one embodiment, a user equipment (UE) is provided. The UE includes a transceiver configured to receive, in a beam indication downlink control information (DCI), a plurality of transmission configuration indication (TCI) states and receive information related to a reference TCI state from among the plurality of TCI states. The UE further includes a processor operably coupled with the transceiver. The processor is configured to identify, based on the information, the reference TCI state from among the plurality of TCI states; determine whether the reference TCI state is updated in the beam indication DCI; and determine, based on whether the reference TCI state was updated in the beam indication DCI, whether to transmit hybrid automatic repeat request acknowledgement (HARQ-ACK) information.

In another embodiment, a base station (BS) is provided. The BS includes a transceiver configured to transmit, in a beam indication DCI, a plurality of TCI states and transmit information related to a reference TCI state from among the plurality of TCI states. The BS further includes a processor operably coupled with the transceiver. The processor is configured to determine whether the reference TCI state is updated in the beam indication DCI and determine, based on whether the reference TCI state was updated in the beam indication DCI, whether to receive HARQ-ACK information.

In yet another embodiment, a method for operating a UE is provided. The method includes receiving, in a beam indication DCI, a plurality of TCI states and receiving information related to a reference TCI state from among the plurality of TCI states. The method further includes identifying, based on the information, the reference TCI state from among the plurality of TCI states; determining whether the reference TCI state is updated in the beam indication DCI; and determining, based on whether the reference TCI state was updated in the beam indication DCI, whether to transmit HARQ-ACK information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of a gNB according to embodiments of the present disclosure;

FIG. 3 illustrates an example of a UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure; and

FIG. 8 illustrates an example of multiple TRP system according to embodiments of the present disclosure;

FIG. 9 illustrates an example of a BFR procedure according to embodiments of the present disclosure;

FIG. 10 illustrates another example of a BFR procedure according to embodiments of the present disclosure; and

FIG. 11 illustrates an example method for receiving a beam indication by a UE in a wireless communication system according to embodiments of the present disclosure

### DETAILED DESCRIPTION

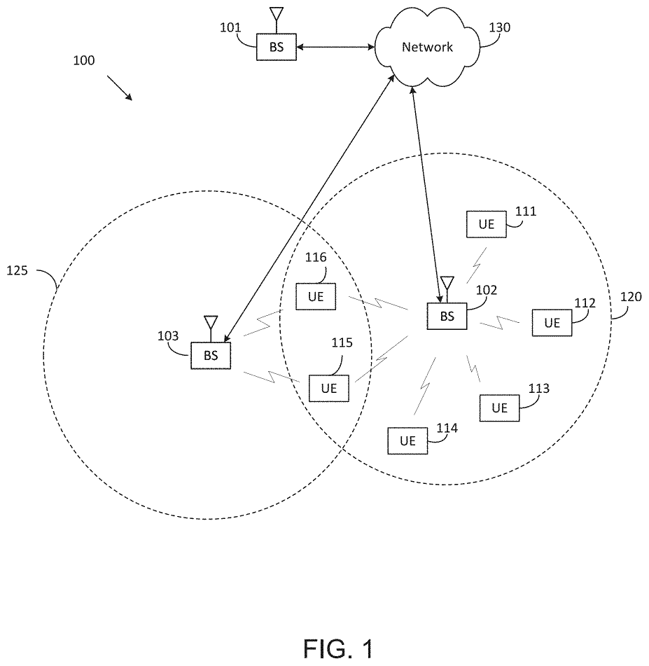

FIG. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a beam indication in a wireless communication system. In certain embodiments, and one or more of the gNBs 101-103 includes circuitry, programing, or a combination thereof, for a beam indication in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

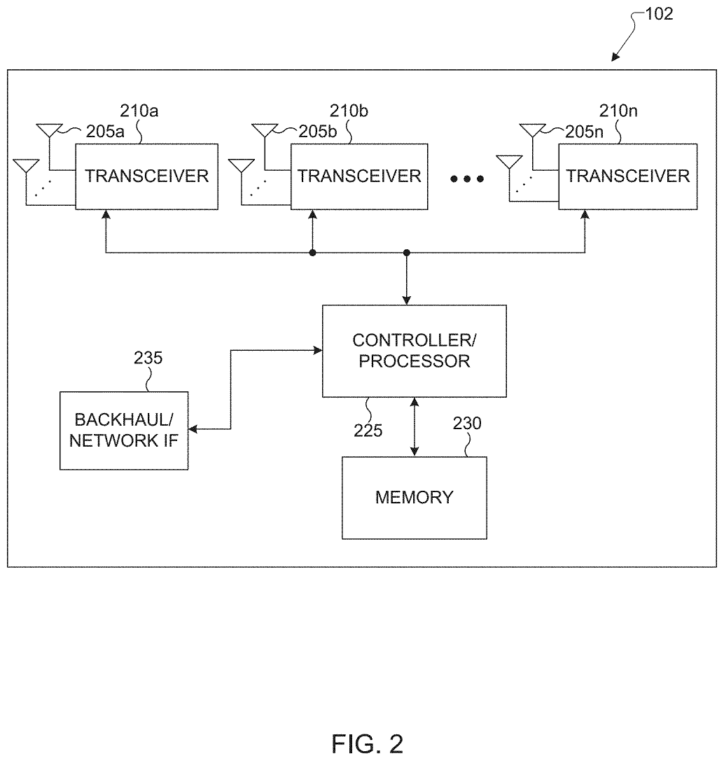

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for a beam indication in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

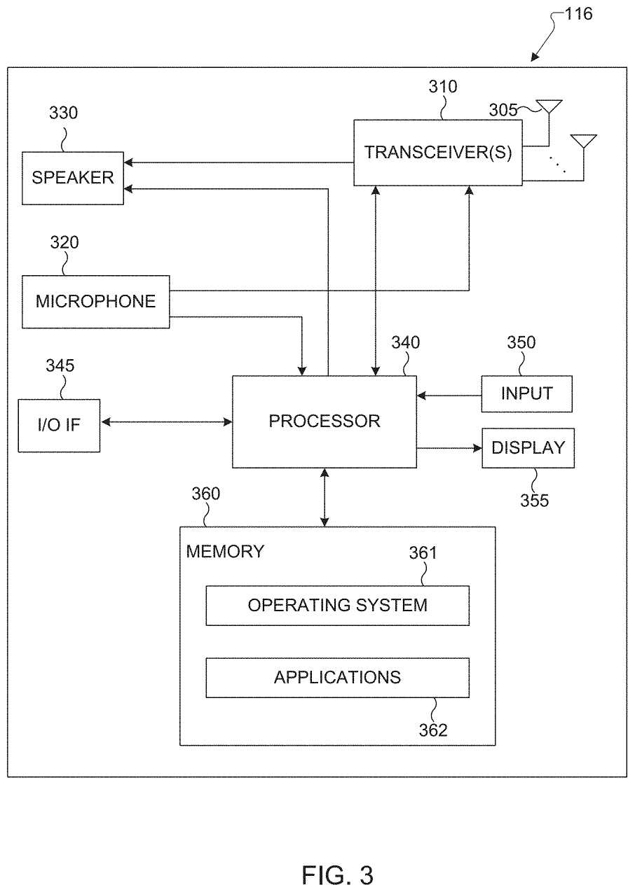

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a beam indication in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

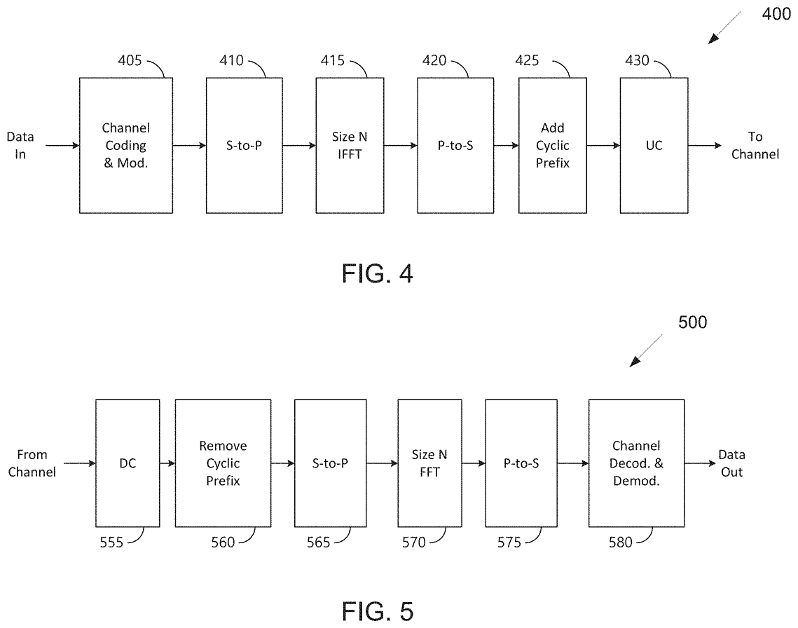

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNB s 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

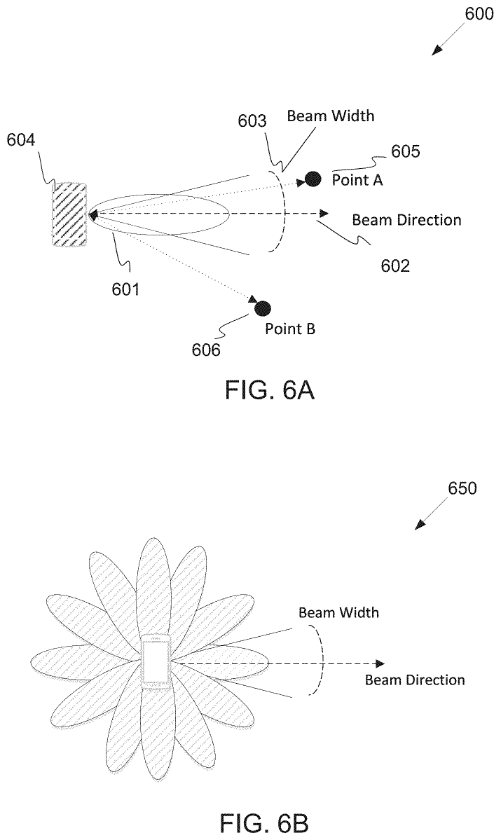

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

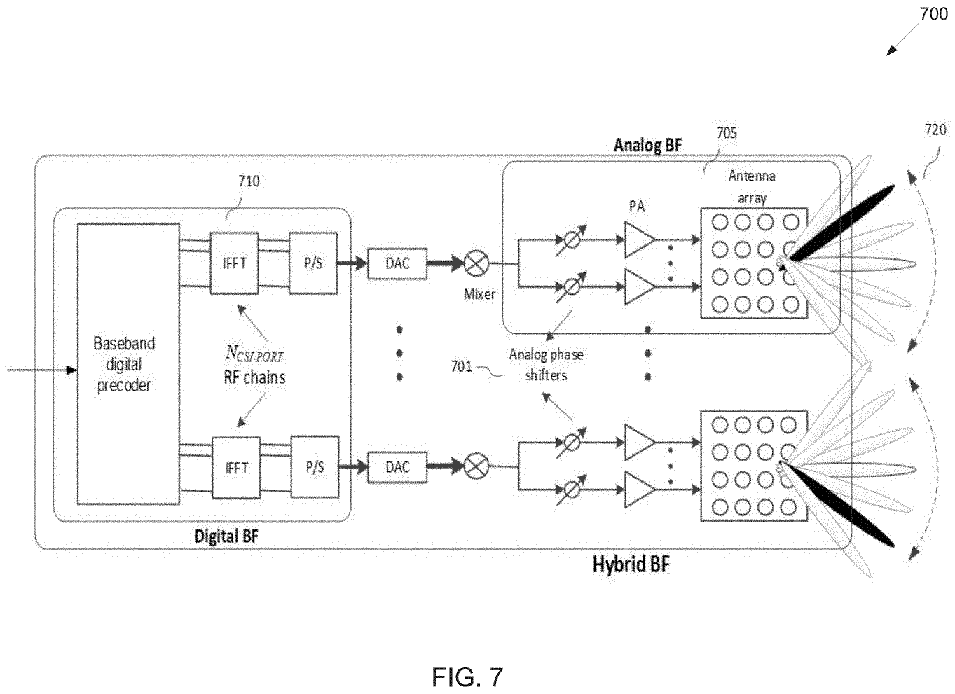

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

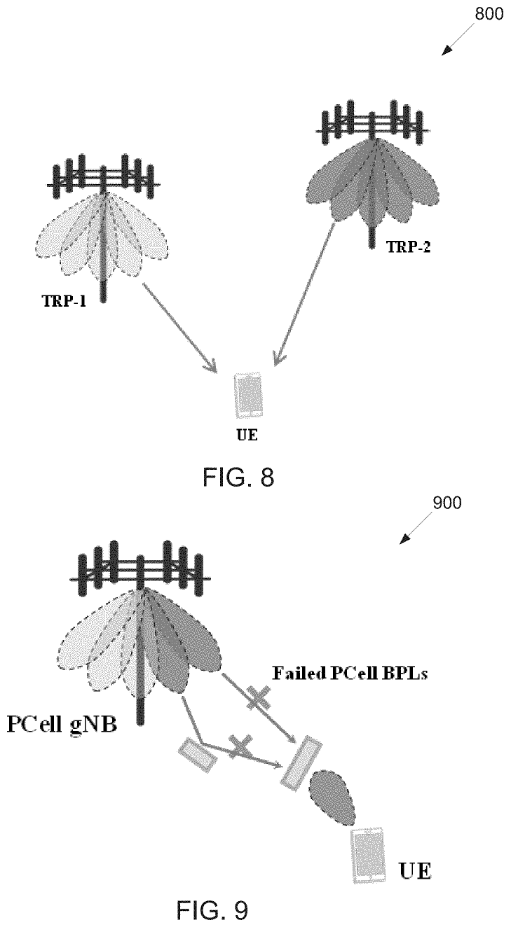

FIG. 8 illustrates an example of multiple TRP system 800 according to embodiments of the present disclosure. The embodiment of the multiple TRP system 800 illustrated in FIG. 8 is for illustration only.

In a multiple TRP system depicted in FIG. 8, the UE could simultaneously receive from multiple physically non-co-located TRPs various channels/RSs such as PDCCHs and/or PDSCHs using either a single RX panel or multiple RX panels. In this disclosure, a RX panel could correspond to a set of RX antenna elements/ports at the UE, a set of measurement RS resources such as SRS resources, a spatial domain RX filter or etc. Further, a TRP in the multi-TRP system can represent a collection of measurement antenna ports, measurement RS resources and/or CORESETs.

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and (5) a plurality of CORESETs associated with a TRP-specific index/indicator/identity.

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation considered in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI or a different PCI (with respect to the serving cell PCI).

Under Rel. 17 unified TCI framework, beam indication for the multi-TRP operation needs to be specified. Especially for a single-DCI (sDCI) based multi-TRP system, solutions for associating an indicated Rel. 17 unified TCI state to one or more PDCCH transmissions, transmitting HARQ-ACK information corresponding to the DCI for unified TCI state indication, or determining the beam application time are needed.

The present disclosure provides various design aspects related to beam indication for single-DCI based multi-TRP operation under the Rel. 17 unified TCI state framework.

As described in the U.S. patent application Ser. No. 17/584,239 incorporated as a reference in its entirety, a unified TCI framework could indicate/include N≥1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; and (4) separate DL TCI state and UL TCI state and/or their corresponding/associated TCI state ID(s).

There could be various design options/channels to indicate to the UE a beam (i.e., a TCI state) for the transmission/reception of a PDCCH or a PDSCH. As described in the U.S. patent application Ser. No. 17/584,239 incorporated as a reference in its entirety, following examples are provided.

In one example, a MAC CE could be used to indicate to the UE a beam (i.e., a TCI state and/or a TCI state ID) for the transmission/reception of a PDCCH or a PDSCH.

In another example, a DCI could be used to indicate to the UE a beam (i.e., a TCI state and/or a TCI state ID) for the transmission/reception of a PDCCH or a PDSCH.

For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.

For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant. Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state can be used at least for UE-dedicated DL channels; and (3) in case of separate TCI state indication, wherein different beams are used for DL and UL channels, a UL TCI state can be used at least for UE-dedicated UL channels.

The unified (master or main) TCI state is a TCI state of UE-dedicated reception on PDSCH/PDCCH or dynamic-grant/configured-grant based PUSCH and all of dedicated PUCCH resources.

Throughout the present disclosure, the term “configuration” or “higher layer configuration” and variations thereof (such as “configured” and so on) could be used to refer to one or more of: a system information signaling such as by a MIB or a SIB (such as SIB 1), a common or cell-specific higher layer/RRC signaling, or a dedicated or UE-specific or BWP-specific higher layer/RRC signaling.

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values: (1) ‘typeA’: {Doppler shift, Doppler spread, average delay, delay spread}, (2) ‘typeB’: {Doppler shift, Doppler spread}, (3) ‘typeC’: {Doppler shift, average delay}, and (4) ‘typeD’: {Spatial Rx parameter}.

The UE can be configured with a list of up to 128 DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS.

If the DLorJointTCIState or UL-TCIState configurations are absent in a BWP of the CC, the UE can apply the DLorJointTCIState or UL-TCIState configurations from a reference BWP of a reference CC. The UE is not expected to be configured with TCI-State, SpatialRelationInfo or PUCCH-SpatialRelationInfo, except SpatialRelationInfoPos in a CC in a band, if the UE is configured with DLorJointTCIState or UL-TCIState in any CC in the same band. The UE can assume that when the UE is configured with TCI-State in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with DLorJointTCIState or UL-TCIState in any CC within the same band in the CC list.

The UE receives an activation command, as described in clause 6.1.3.14 of [10, TS 38.321] or 6.1.3.x of [10, TS 38.321], used to map up to 8 TCI states and/or pairs of TCI states, with one TCI state for DL channels/signals and one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.

The Unified TCI States Activation/Deactivation MAC CE is identified by a MAC subheader with eLCID as specified in Table 6.2.1-1b in TS 38.321. It has a variable size consisting of one or more of the following fields: (1) serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331, this MAC CE applies to all theServing Cells in the set simultaneousU-TCI-UpdateList1, simultaneousU-TCI-UpdateList2, simultaneousU-TCI-UpdateList3 or simultaneousU-TCI-UpdateList4, respectively; (2) DL BWP ID: This field indicates a DL BWP for which the MAC CE applies as the codepoint of the DCI bandwidth part indicator field as specified in TS 38.212. The length of the BWP ID field is 2 bits; (3) UL BWP ID: This field indicates a UL BWP for which the MAC CE applies as the codepoint of the DCI bandwidth part indicator field as specified in TS 38.212. The length of the BWP ID field is 2 bits; (4) Pᵢ: This field indicates whether each TCI codepoint has multiple TCI states or single TCI state. If Pᵢ field set to 1, it indicates that i^{th} TCI codepoint includes the DL TCI state and the UL TCI state. If Pᵢ field set to 0, it indicates that i^{th} TCI codepoint includes only the DL TCI state or the UL TCI state; (5) D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink; (6) TCI state ID: This field indicates the TCI state identified by TCI-StateId as specified in TS 38.331. If D/U is set to 1, 7-bits length TCI state ID i.e. TCI-StateId as specified in TS 38.331 is used. If D/U is set to 0, the most significant bit of TCI state ID is considered as the reserved bit and remainder 6 bits indicate the UL-TCIState-Id as specified in TS 38.331. The maximum number of activated TCI states is 16; (7) R: Reserved bit, set to 0.

The CellGroupConfig IE specified in the TS 38.331 is used to configure a master cell group (MCG) or secondary cell group (SCG). A cell group comprises of one MAC entity, a set of logical channels with associated RLC entities and of a primary cell (SpCell) and one or more secondary cells (SCells).

simultaneousTCI-UpdateList1, simultaneousTCI-UpdateList2 are list of serving cells which can be updated simultaneously for TCI relation with a MAC CE. The simultaneousTCI-UpdateList1 and simultaneousTCI-UpdateList2 shall not contain same serving cells. Network should not configure serving cells that are configured with a BWP with two different values for the coresetPoolIndex in these lists.

simultaneousU-TCI-UpdateList1, simultaneousU-TCI-UpdateList2, simultaneousU-TCI-UpdateList3, simultaneousU-TCI-UpdateList4 are list of serving cells for which the Unified TCI States Activation/Deactivation MAC CE applies simultaneously, as specified in [TS 38.321 v17.1.0 clause 6.1.3.47]. The different lists shall not contain same serving cells. Network only configures in these lists serving cells that are configured with unifiedtci-StateType.

When the bwp-id or cell for QCL-TypeA/D source RS in a QCL-Info of the TCI state configured with DLorJointTCIState is not configured, the UE assumes that QCL-TypeA/D source RS is configured in the CC/DL BWP where TCI state applies.

When tci-PresentInDCI is set as ‘enabled’ or tci-PresentDCI-1-2 is configured for the CORESET, the UE with activated DLorJointTCIState or UL-TCIState receives DCI format 1_1/1_2 providing indicated DLorJointTCIState or UL-TCIState for a CC or all CCs in the same CC list configured by simultaneousTCI-UpdateList1-r17, simultaneousTCI-UpdateList2-r17, simultaneousTCI-UpdateList3-r17, simultaneousTCI-UpdateList4-r17. The DCI format 1_1/1_2 can be with or without, if applicable, DL assignment. If the DCI format 1_1/1_2/ is without DL assignment, the UE can assume the following: (1) CS-RNTI is used to scramble the CRC for the DCI, (2) the values of the following DCI fields are set as follows: RV=all ‘1’s, MCS=all ‘1’s, NDI=0, and set to all ‘0’s for FDRA Type 0, or all ‘1’s for FDRA Type 1, or all ‘0’s for dynamicSwitch (same as in Table 10.2-4 of [6, TS 38.213]).

After a UE receives an initial higher layer configuration of more than one DLorJoint-TCIState and before application of an indicated TCI state from the configured TCI states: the UE assumes that DM-RS of PDSCH and DM-RS of PDCCH and the CSI-RS applying the indicated TCI state are quasi co-located with the SS/PBCH block the UE identified during the initial access procedure.

After a UE receives an initial higher layer configuration of more than one DLorJoint-TCIState or UL-TCIState and before application of an indicated TCI state from the configured TCI states: the UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during the initial access procedure.

After a UE receives a higher layer configuration of more than one DLorJoint-TCIState as part of a Reconfiguration with sync procedure as described in [12, TS 38.331] and before applying an indicated TCI state from the configured TCI states: the UE assumes that DM-RS of PDSCH and DM-RS of PDCCH, and the CSI-RS applying the indicated TCI state are quasi co-located with the SS/PBCH block or the CSI-RS resource the UE identified during the random access procedure initiated by the Reconfiguration with sync procedure as described in [12, TS 38.331].

After a UE receives a higher layer configuration of more than one DLorJoint-TCIState or UL-TCIState as part of a Reconfiguration with sync procedure as described in [12, TS 38.331] and before applying an indicated TCI state from the configured TCI states: the UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during random access procedure initiated by the Reconfiguration with sync procedure as described in [12, TS 38.331].

If a UE receives a higher layer configuration of a single DLorJoint-TCIState, that can be used as an indicated TCI state, the UE obtains the QCL assumptions from the configured TCI state for DM-RS of PDSCH and DM-RS of PDCCH, and the CSI-RS applying the indicated TCI state.

If a UE receives a higher layer configuration of a single DLorJoint-TCIState or UL-TCIState, that can be used as an indicated TCI state, the UE determines an UL TX spatial filter, if applicable, from the configured TCI state for dynamic-grant and configured-grant based PUSCH and PUCCH, and SRS applying the indicated TCI state.

When the UE would transmit the last symbol of a PUCCH with HARQ-ACK information corresponding to the DCI carrying the TCI State indication and without DL assignment, or corresponding to the PDSCH scheduling by the DCI carrying the TCI State indication, and if the indicated TCI State is different from the previously indicated one, the indicated DLorJointTCIState or UL-TCIstate should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

If a UE is configured with pdsch-TimeDomainAllocationListForMultiPDSCH-r17 in which one or more rows contain multiple SLIVs for PDSCH on a DL BWP of a serving cell, and the UE is receiving a DCI carrying the TCI-State indication and without DL assignment, the UE does not expect that the number of indicated SLIVs in the row of the pdsch-TimeDomainAllocationListForMultiPDSCH-r17 by the DCI is more than one.

If the UE is configured with NumberOfAdditionalPCI and with PDCCH-Config that contains two different values of coresetPoolIndex in ControlResourceSet, the UE receives an activation command for CORESET associated with each coresetPoolIndex, as described in clause 6.1.3.14 of [10, TS 38.321], used to map up to 8 TCI states to the codepoints of the DCI field ‘Transmission Configuration Indication’ in one CC/DL BWP. When a set of TCI state IDs are activated for a coresetPoolIndex, the activated TCI states corresponding to one coresetPoolIndex can be associated with one physical cell ID and activated TCI states corresponding to another coresetPoolIndex can be associated with another physical cell ID.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where m is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling a PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the ULE assumes that the TCI state or the QCL assumption for the PDSCH is identical to the TCI state or QCL assumption whichever is applied for the CORESET used for the PDCCH transmission within the active BWP of the serving cell.

When a UE is configured with both sfnSchemePdcch and sfnSchemePdsch scheduled by DCI format 10 or by DCI format 1_1/1_2, if the time offset between the reception of the DL DCI and the corresponding PDSCH of a serving cell is equal to or greater than a threshold timeDurationForQCL if applicable: if the UE supports DCI scheduling without TCI field, the UE assumes that the TCI state(s) or the QCL assumption(s) for the PDSCH is identical to the TCI state(s) or QCL assumption(s) whichever is applied for the CORESET used for the reception of the DL DCI within the active BWP of the serving cell regardless of the number of active TCI states of the CORESET. If the UE does not support dynamic switching between SFN PDSCH and non-SFN PDSCH, the UE should be activated with the CORESET with two TCI states; else if the UE does not support DCI scheduling without TCI field, the UE shall expect TCI field present when scheduled by DCI format 1_1/1_2.

When a UE is configured with sfnSchemePdsch and sfnSchemePdcch is not configured, when scheduled by DCI format 1_1/1_2, if the time offset between the reception of the DL DCI and the corresponding PDSCH of a serving cell is equal to or greater than a threshold timeDurationForQCL if applicable, the UE shall expect TCI field present.

For PDSCH scheduled by DCI format 10, 11, 1_2, when a UE is configured with sfnSchemePdcch set to ‘sfnSchemeA’ and sfnSchemePdsch is not configured, and there is no TCI codepoint with two TCI states in the activation command, and if the time offset between the reception of the DL DCI and the corresponding PDSCH is equal or larger than the threshold timeDurationForQCL if applicable and the CORESET which schedules the PDSCH is indicated with two TCI states, the UE assumes that the TCI state or the QCL assumption for the PDSCH is identical to the first TCI state or QCL assumption which is applied for the CORESET used for the PDCCH transmission within the active BWP of the serving cell.

If a PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [13, TS 38.306]. For a single slot PDSCH, the indicated TCI state(s) should be based on the activated TCI states in the slot with the scheduled PDSCH. For a multi-slot PDSCH or the UE is configured with higher layer parameter pdsch-TimeDomainAllocationListForMultiPDSCH-r17, the indicated TCI state(s) should be based on the activated TCI states in the first slot with the scheduled PDSCH(s), and UE shall expect the activated TCI states are the same across the slots with the scheduled PDSCH(s). When the UE is configured with CORESET associated with a search space set for cross-carrier scheduling and the UE is not configured with enableDefaultBeamForCCS, the UE expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and a corresponding PDSCH is larger than or equal to the threshold timeDurationForQCL.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, If a UE is configured with enableDefaultTCI-StatePerCoresetPoolIndex and the UE is configured by higher layer parameter PDCCH-Config that contains two different values of coresetPoolIndex in different ControlResourceSets, the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same value of coresetPoolIndex, the UE is expected to prioritize the reception of PDCCH associated with that CORESET. This also applies to the intra-band CA case (when PDSCH and the CORESET are in different component carriers).

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 in TS 38.214 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, if a UE is not configured with sfnSchemePdsch, and the UE is configured with sfnSchemePdcch set to ‘sfnSchemeA’ and there is no TCI codepoint with two TCI states in the activation command and the CORESET with the lowest ID in the latest slot is indicated with two TCI states, the UE may assume that the DM-RS ports of PDSCH of a serving cell are quasi co-located with the RS(s) with respect to the QCL parameter(s) associated with the first TCI state of two TCI states indicated for the CORESET.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, in all cases above, if none of configured TCI states for the serving cell of scheduled PDSCH is configured with qcl-Type set to ‘typeD’, the UE shall obtain the other QCL assumptions from the indicated TCI state(s) for its scheduled PDSCH irrespective of the time offset between the reception of the DL DCI and the corresponding PDSCH.

If the PDCCH carrying the scheduling DCI is received on one component carrier, and a PDSCH scheduled by that DCI is on another component carrier: (1) the timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1 in TS 38.214, otherwise d is zero; or (2) when the UE is configured with enableDefaultBeamForCCS, if the offset between the reception of the DL DCI and the corresponding PDSCH is less than the threshold timeDurationForQCL, or if the DL DCI does not have the TCI field present, the UE obtains its QCL assumption for the scheduled PDSCH from the activated TCI state with the lowest ID applicable to PDSCH in the active BWP of the scheduled cell.

A UE that has indicated a capability beamCorrespondenceWithoutUL-BeamSweeping set to ‘1’, as described in [18, TS 38.822], can determine a spatial domain filter to be used while performing the applicable channel access procedures described in [16, TS 37.213] to transmit a UL transmission on the channel as follows: (1) if UE is indicated with an SRI corresponding to the UL transmission, the UE may use a spatial domain filter that is same as the spatial domain transmission filter associated with the indicated SRI, or (2) if UE is configured with TCI-State configurations with DLorJointTCIState or UL-TCIState, the UE may use a spatial domain transmit filter that is same as the spatial domain receive filter the UE may use to receive the DL reference signal associated with the indicated TCI state.

When the PDCCH reception includes two PDCCH from two respective search space sets, as described in clause 10.1 of [6, TS 38.213], for the purpose of determining the time offset between the reception of the DL DCI and the corresponding PDSCH, the PDCCH candidate that ends later in time is used. When the PDCCH reception includes two PDCCH candidates from two respective search space sets, as described in clause 10.1 of [6, TS 38.213], for the configuration of tci-PresentInDCI or tci-PresentDCI-1-2, the UE expects the same configuration in the first and second CORESETs associated with the two PDCCH candidates; and if the PDSCH is scheduled by a DCI format not having the TCI field present and if the scheduling offset is equal to or larger than timeDurationForQCL, if applicable, PDSCH QCL assumption is based on the CORESET with lower ID among the first and second CORESETs associated with the two PDCCH candidates.

For a periodic CSI-RS resource in an NZP-CSI-RS-ResourceSet configured with higher layer parameter trs-Info, the UE shall expect that a TCI-State indicates one of the following quasi co-location type(s): (1) ‘typeC’ with an SS/PBCH block and, when applicable, ‘typeD’ with the same SS/PBCH block, or (2)‘typeC’ with an SS/PBCH block and, when applicable, ‘typeD’ with a CSI-RS resource in an NZP-CSI-RS-ResourceSet configured with higher layer parameter repetition.

For periodic/semi-persistent CSI-RS, the UE can assume that the indicated DLorJointTCIState is not applied.

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with an SS/PBCH block, (3) ‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or (4) ‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s): (1)‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, (3)‘typeC’ with an SS/PBCH block and, when applicable, ‘typeD’ with the same SS/PBCH block, the reference RS may additionally be an SS/PBCH block having a PCI different from the PCI of the serving cell. The UE can assume center frequency, SCS, SFN offset are the same for SS/PBCH block from the serving cell and SS/PBCH block having a PCI different from the serving cell.

For the DM-RS of PDCCH, the UE shall expect that a TCI-State or DLorJointTCIState except an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or (3) ‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

When a UE is configured with sfnSchemePdcch set to ‘sfnSchemeA’, and CORESET is activated with two TCI states, the UE shall assume that the DM-RS port(s) of the PDCCH in the CORESET is quasi co-located with the DL-RSs of the two TCI states. When a UE is configured with sfnSchemePdcch set to ‘sfnSchemeB’, and a CORESET is activated with two TCI states, the UE shall assume that the DM-RS port(s) of the PDCCH is quasi co-located with the DL-RSs of the two TCI states except for quasi co-location parameters {Doppler shift, Doppler spread} of the second indicated TCI state.

For the DM-RS of PDSCH, the UE shall expect that a TCI-State or DLorJointTCIState except an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or (3) ‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDCCH, the UE shall expect that an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, or (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

For the DM-RS of PDSCH, the UE shall expect that an indicated DLorJointTCIState indicates one of the following quasi co-location type(s) if the UE is configured TCI-State(s) with tci-StateId_r17: (1)‘typeA’ with a CSI-RS resource in a NZP-CSI-RS-ResourceSet configured with higher layer parameter trs-Info and, when applicable, ‘typeD’ with the same CSI-RS resource, or (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

When a UE is configured with sfnSchemePdsch set to ‘sfnSchemeA’, and the UE is indicated with two TCI states in a codepoint of the DCI field ‘Transmission Configuration Indication’ in a DCI scheduling a PDSCH, the UE shall assume that the DM-RS port(s) of the PDSCH is quasi co-located with the DL-RSs of the two TCI states. When a UE is configured with sfnSchemePdsch set to ‘sfnSchemeB’, and the UE is indicated with two TCI states in a codepoint of the DCI field ‘Transmission Configuration Indication’ in a DCI scheduling a PDSCH, the UE shall assume that the DM-RS port(s) of the PDSCH is quasi co-located with the DL-RSs of the two TCI states except for quasi co-location parameters {Doppler shift, Doppler spread} of the second indicated TCI state.

Throughout the present disclosure, the joint (e.g., provided by DLorJoint-TCIState), separate DL (e.g., provided by DLorJoint-TCIState) and/or separate UL (e.g., provided by UL-TCIState) TCI states described/discussed herein could also be referred to as unified TCI states, common TCI states, main TCI states and etc.

In one embodiment, various unified TCI state/beam indication methods for a single-DCI (sDCI) based multi-TRP system are provided.

As discussed above, in a single-DCI (sDCI) based multi-TRP system, a UE could be provided by the network, e.g., via MAC CE or DCI (e.g., DCI format 1_1 or 1_2 with or without DL assignment) based signaling through the higher layer parameter TCI-State_r17, M>1 joint DL and UL Rel. 17 unified TCI states or M>1 separate UL Rel. 17 unified TCI states or a first combination of M>1 joint DL and UL Rel. 17 unified TCI states and separate UL Rel. 17 unified TCI states or N>1 separate DL Rel. 17 unified TCI states or a second combination of N>1 joint DL and UL Rel. 17 unified TCI states and separate DL Rel. 17 unified TCI states or a third combination of N>1 joint DL and UL Rel. 17 unified TCI states, separate DL Rel. 17 unified TCI states and separate UL Rel. 17 unified TCI for UE-dedicated reception on PDSCH/PDCCH or dynamic-grant/configured-grant based PUSCH and all of dedicated PUCCH resources.

For instance, the DCI format for unified TCI state/beam indication (e.g., DCI format 1_1 or 1_2 with or without DL assignment) could include a “transmission configuration indication” field containing one or more codepoints activated by a first MAC CE activation command from a set/pool of codepoints. For this case, each codepoint could indicate M>1 joint DL and UL Rel. 17 unified TCI states or M>1 separate UL Rel. 17 unified TCI states or a first combination of M>1 joint DL and UL Rel. 17 unified TCI states and separate UL Rel. 17 unified TCI states or N>1 separate DL Rel. 17 unified TCI states or a second combination of N>1 joint DL and UL Rel. 17 unified TCI states and separate DL Rel. 17 unified TCI states or a third combination of N>1 joint DL and UL Rel. 17 unified TCI states, separate DL Rel. 17 unified TCI states and separate UL Rel. 17 unified TCI for UE-dedicated reception on PDSCH/PDCCH or dynamic-grant/configured-grant based PUSCH and all of dedicated PUCCH resources.

Throughout the present disclosure, a Rel. 17 unified TCI state can also be referred to as a TCI state or a unified TCI state corresponding to a joint DL/UL TCI state or a DL TCI state provided by DLorJointTCI-State/TCI-State or a UL TCI state provided by UL-TCIState/TCI-State.

In a single-DCI (sDCI) based multi-TRP system, a UE could receive PDCCHs only in sDCI CORESETs, which could be determined according to at least one of examples.

In one example, CORESETs not associated with any CORESETPoolIndex values are sDCI CORESETs. For instance, the UE is not provided by the higher layer parameter PDCCH-Config in ControlResourceSet any CORESETPoolIndex values. In this case, all CORESETs could be sDCI CORESETs.

In another example, the UE could be provided by the higher layer parameter PDCCH-Config that contains multiple (e.g., two) values of CORESETPoolIndex (e.g., 0 and 1) in ControlResourceSet. For this case, the sDCI CORESETs (provided by the higher layer parameter ControlResourceSet) are associated with a specific CORESETPoolIndex value (e.g., 0 or 1).

In yet another example, the UE could be provided by the higher layer parameter PDCCH-Config that contains a single value of CORESETPoolIndex (e.g., 0 or 1) in ControlResourceSet. For this case, the sDCI CORESETs (provided by the higher layer parameter ControlResourceSet) are associated with the provided CORESETPoolIndex value (e.g., 0 or 1).

In yet another example, the UE is not provided by the higher layer parameter PDCCH-Config in ControlResourceSet any CORESETPoolIndex values. For this case, the UE assumes CORESETPoolIndex value 0 for all CORESETs. The sDCI CORESETs (provided by the higher layer parameter ControlResourceSet) are associated with the CORESETPoolIndex value 0.

Furthermore, one or more CORESETs in the sDCI based multi-TRP system could be configured with a same group index, denoted by CORESETGroupIndex. The CORESETs configured with the same CORESETGroupIndex value could be associated with the same TRP in a multi-TRP system. The UE could be provided by PDCCH-Config one or more (e.g., two) CORESETGroupIndex values (e.g., 0 and/or 1). The association of a CORESET and a CORESETGroupIndex value could be via indicating the explicit CORESETGroupIndex value (e.g., either 0 or 1) in the parameter, e.g., the higher layer parameter ControlResourceSet, configuring the CORESET.

For this case, the sDCI CORESETs could be determined according to at least one of examples.

In one example, CORESETs not associated with any CORESETGroupIndex values are sDCI CORESETs. For instance, the UE is not provided by the higher layer parameter PDCCH-Config in ControlResourceSet any CORESETGroupIndex values. In this case, all CORESETs could be sDCI CORESETs.

In another example, the UE could be provided by the higher layer parameter PDCCH-Config that contains multiple (e.g., two) values of CORESETGroupIndex (e.g., 0 and 1) in ControlResourceSet. For this case, the sDCI CORESETs (provided by the higher layer parameter ControlResourceSet) are associated with a specific CORESETGroupIndex value (e.g., 0 or 1).

In yet another example, the UE could be provided by the higher layer parameter PDCCH-Config that contains a single value of CORESETGroupIndex (e.g., 0 or 1) in ControlResourceSet. For this case, the sDCI CORESETs (provided by the higher layer parameter ControlResourceSet) are associated with the provided CORESETGroupIndex value (e.g., 0 or 1).

In yet another example, the UE is not provided by the higher layer parameter PDCCH-Config in ControlResourceSet any CORESETGroupIndex values. For this case, the UE assumes CORESETGroupIndex value 0 for all CORESETs. The sDCI CORESETs (provided by the higher layer parameter ControlResourceSet) are associated with the CORESETGroupIndex value 0.

In addition to the above discussed design examples, a CORESET, in which a DCI format scheduling more than one PDSCHs whose DM-RS antenna ports are quasi co-located with reference signals provided in different TCI states are received, could be a sDCI CORESET.

Furthermore, DM-RS antenna ports for PDCCH receptions in one or more sDCI CORESETs could be quasi co-located with reference signal(s) provided in an indicated reference Rel. 17 unified TCI state—e.g., one out of the indicated M>1 joint DL and UL TCI states or M>1 separate UL TCI states or N>1 separate DL TCI states. In the present disclosure, the sDCI CORESETs whose QCL assumption(s) follow that provided in the reference Rel. 17 unified TCI state or sharing the reference Rel. 17 unified TCI state is referred to as Type-1 sDCI CORESET(s), while the sDCI CORESET(s) whose QCL assumption(s) does not follow that provided in the reference Rel. 17 unified TCI state or not sharing the reference Rel. 17 unified TCI state is referred to as Type-2 sDCI CORESET(s).

Furthermore, a Type-1 sDCI CORESET or a Type-2 sDCI CORESET could correspond to one or more of: (1) “CORESET A”: a CORESET other than CORESET with index 0 (or CORESET #0) associated with only UE-dedicated PDCCH reception(s) in a CC, comprising, e.g., CORESET(s) associated with USS set(s) or Type3-PDCCH CSS set(s); (2) “CORESET B”: a CORESET other than CORESET #0 associated with only non-UE-dedicated PDCCH reception(s) in a CC, comprising, e.g., CORESET(s) associated with all types of CSS sets such as Type0/0A/1/2/3-PDCCH CSS sets or CSS sets other than Type3-PDCCH CSS set(s) such as Type0/0A/1/2-PDCCH CSS sets; (3) “CORESET C”: a CORESET other than CORESET #0 associated with both UE-dedicated and non-UE-dedicated PDCCH receptions in a CC; and (4) CORESET #0, i.e., CORESET with index 0.

The UE could be provided/configured with “useIndicatedR17TCIState” for one or more of the Type-1 sDCI CORESETs. For instance, the UE could be provided/configured with “useIndicatedR17TCIstate” set to “enabled” in the parameter, e.g., the higher layer parameter ControlResourceSet, that configures the corresponding Type-1 sDCI CORESET(s).

In the present disclosure, in the single-DCI based multi-TRP system, the indicated Rel. 17 unified TCI state n or m (n∈{1, . . . , N} and m∈{1, . . . , M}) could correspond to the n-th joint DL and UL TCI state or the m-th separate UL TCI state or the n-th separate DL TCI state or the m-th TCI state in the first combination of TCI states or the n-th TCI state in the second combination of TCI states or the n-th TCI state in the third combination of TCI states or the joint DL and UL TCI state with the n-th lowest or highest TCI state ID or the separate UL TCI state with the m-th lowest or highest TCI state ID or the separate DL TCI state with the n-th lowest or highest TCI state ID or the TCI state in the first combination of TCI states with the m-th lowest or highest TCI state ID or the TCI state in the second combination of TCI states with the n-th lowest or highest TCI state ID or the TCI state in the third combination of TCI states with the n-th lowest or highest TCI state ID, among the N>1 or M>1 Rel. 17 unified TCI states, indicated via the MAC CE or DCI (e.g., DCI format 1_1 or 1_2 with or without DL assignment) based signaling.

For sDCI based multi-TRP operation, DM-RS antenna ports for PDCCH receptions in the same or different sDCI CORESETs could be quasi co-located with reference signals provided in the indicated reference Rel. 17 unified TCI state. Throughout the present disclosure, a reference Rel. 17 unified TCI state can also be referred to as a reference TCI state or a reference unified TCI state corresponding to a joint DL/UL TCI state or a DL TCI state provided by DLorJointTCI-State/TCI-State or a UL TCI state provided by UL-TCIState/TCI-State. When a UE receives from the network M>1 or N>1 Rel. 17 unified TCI states indicated by a codepoint in a DCI (e.g., DCI format 1_1 or 1_2 with or without DL assignment) or MAC CE, the reference Rel. 17 unified TCI state for the sDCI CORESET(s) could be determined according to at least one of examples.

In one example, DM-RS antenna ports for PDCCH receptions in the same or different sDCI CORESETs or Type-1 sDCI CORESETs could be quasi co-located with reference signals provided in the reference Rel. 17 unified TCI state, which could correspond to at least one of: (i) the first indicated Rel. 17 unified TCI state, (ii) the last indicated Rel. 17 unified TCI state, (iii) the indicated Rel. 17 unified TCI state with the lowest TCI state ID/index, or (iv) the indicated Rel. 17 unified TCI state with the highest TCI state ID/index, among the N>1 (or M>1) Rel. 17 unified TCI states indicated by a codepoint in a DCI (e.g., DCI format 1_1 or 1_2 with or without DL assignment) or MAC CE.

In another example, DM-RS antenna ports for PDCCH receptions in the same or different sDCI CORESETs or Type-1 sDCI CORESETs could be quasi co-located with reference signals provided in the reference Rel. 17 unified TCI state, which could correspond to the indicated Rel. 17 unified TCI state n or m, where n∈{1, . . . , N} and m∈{1, . . . , M}. For example, the UE could be higher layer configured by the network, e.g., via higher layer RRC signaling, TCI state index/ID corresponding to the Rel. 17 unified TCI state n (or m) among the N>1 (or M>1) Rel. 17 unified TCI states indicated by a codepoint in a DCI or MAC CE. For another example, the RRC configuration could contain/include a bitmap of length N (or M) with each bit/bit position in the bitmap corresponding to an indicated Rel. 17 unified TCI state; for this case, the UE could receive from the network the bitmap with the n-th (or m-th) bit/bit position set to “1.”

Yet for another example, for N=2 or M=2, the RRC configuration could contain/correspond to a one-bit flag indicator with “0” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the first indicated Rel. 17 unified TCI state or the indicated Rel. 17 unified TCI state with the lowest (or highest) TCI state ID/index, and “1” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the second indicated Rel. 17 unified TCI state or the indicated Rel. 17 unified TCI state with the highest (or lowest) TCI state ID/index, or vice versa.

In yet another example, DM-RS antenna ports for PDCCH receptions in the same or different sDCI CORESETs or Type-1 sDCI CORESETs could be quasi co-located with reference signals provided in the reference Rel. 17 unified TCI state, which could correspond to the indicated Rel. 17 unified TCI state n or m, where n∈{1, . . . , N} and m∈{1, . . . , M}. For example, the UE could receive from the network a MAC CE indicating TCI state index/ID corresponding to the Rel. 17 unified TCI state n (or m) among the N>1 (or M>1) Rel. 17 unified TCI states indicated by a codepoint in a DCI or MAC CE. For another example, the UE could receive from the network a second MAC CE activation command to activate the Rel. 17 unified TCI state n (or m) from the N>1 (or M>1) Rel. 17 unified TCI states indicated by a codepoint in a DCI or MAC CE. For example, the second MAC CE activation command could correspond to a bitmap of length N (or M) with each bit/bit position in the bitmap corresponding to an indicated Rel. 17 unified TCI state.

For this case, the UE could receive from the network the bitmap with the n-th (or m-th) bit/bit position set to “1.” Yet for another example, for N=2 or M=2, the second MAC CE activation command could contain/correspond to a one-bit flag indicator with “0” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the first indicated Rel. 17 unified TCI state or the indicated Rel. 17 unified TCI state with the lowest (or highest) TCI state ID/index, and “1” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the second indicated Rel. 17 unified TCI state or the indicated Rel. 17 unified TCI state with the highest (or lowest) TCI state ID/index, or vice versa. The second MAC CE activation command could be the same as the first MAC CE activation command used for activating one or more codepoints from a set/pool of codepoints to indicate the N>1 (M>1) unified TCI states as discussed above.

In yet another example, an indicated Rel. 17 unified TCI state, e.g., the corresponding higher layer parameter TCI-State_r17, could include a “CORESET indicator” field. For example, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORESET indicator” field set to “enabled.” For another example, the “CORESET indicator” field could indicate CORESETPoolIndex value(s).

For this case, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORESET indicator” field indicating value 0 of CORESETPoolIndex. Yet for another example, the “CORESET indicator” field could correspond to a one-bit flag indicator.

For this case, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORESET indicator” indicating logical “1.” Yet for another example, the “CORESET indicator” field could be an entity ID/index corresponding to PCI, TRP ID/index and etc. For this case, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORESET indicator” field indicating a designated entity ID/index—e.g., the serving cell PCI or the first TRP.

In yet another example, DM-RS antenna ports for PDCCH receptions in the same or different sDCI CORESETs or Type-1 sDCI CORESETs could be quasi co-located with reference signals provided in the reference Rel. 17 unified TCI state, which could correspond to the indicated Rel. 17 unified TCI state n or m, where n∈{1, . . . , N} and m∈{1, . . . , M}. In this example, the DCI format (e.g., DCI format 1_1 or 1_2 with or without DL assignment) could include a “CORESET indicator” field. The “CORESET indicator” field could be configured in the same DCI format indicating the N>1 or M>1 Rel. 17 unified TCI states.

For example, the “CORESET indicator” field in the DCI format could indicate TCI state index/ID corresponding to the Rel. 17 unified TCI state n (or m), and therefore the reference Rel. 17 unified TCI state, among the N>1 (or M>1) indicated Rel. 17 unified TCI states. For another example, the “CORESET indicator” field in the DCI format could correspond to a bitmap of length N (or M) with each bit/bit position in the bitmap corresponding to an indicated Rel. 17 unified TCI state. For this case, the n-th (or m-th) bit/bit position in the bitmap is set to “1.”

Yet for another example, for N=2 or M=2, the “CORESET indicator” field in the DCI format could correspond to a one-bit flag indicator with “0” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the first indicated Rel. 17 unified TCI state or the indicated Rel. 17 unified TCI state with the lowest (or highest) TCI state ID/index, and “1” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the second indicated Rel. 17 unified TCI state or the indicated Rel. 17 unified TCI state with the highest (or lowest) TCI state ID/index, or vice versa.

In the present disclosure, the indicated reference Rel. 17 unified TCI state could be a joint DL and UL TCI state or a separate UL TCI state or a separate DL TCI state or a TCI state in the first combination of TCI states or a TCI state in the second combination of TCI states or a TCI state in the third combination of TCI states.

In the above described design examples, the reference unified TCI state is specified/determined/signalled for PDCCH reception—e.g., the UE could be indicated/configured/provided by the network, e.g., via a higher layer RRC parameter/signalling such as ControlResourceSet that configures a CORESET, the reference TCI state for receiving the PDCCH. The same or similar methods of determining or signalling the reference unified TCI state as described herein in the present disclosure could be applied for PDSCH reception, PUCCH transmission or PUSCH transmission. For example, the UE could be indicated/configured/provided by the network, e.g., via a new indicator field or reusing/repurposing an existing indicator field in the scheduling DCI (e.g., DCI format 10, 1_1 or 1_2), the reference TCI state for receiving the scheduled PDSCH. For another example, the UE could be indicated/configured/provided by the network, e.g., via a higher layer RRC parameter/signalling such as PUCCH-Config that configures a PUCCH resource, the reference TCI state for transmitting the PUCCH. Yet for another example, the UE could be indicated/configured/provided by the network, e.g., via a new indicator field or reusing/repurposing an existing indicator field in the scheduling DCI (e.g., DCI format 0_1 or 0_2), the reference TCI state for transmitting the scheduled PUSCH.

As discussed herein in the present disclosure, the reference unified TCI state could be in form of TCI state ID of the reference unified TCI state, index of the reference unified TCI state among all the indicated (e.g., N>1 or M>1) unified TCI states (indicated in the beam indication DCI or MAC CE as specified herein in the present disclosure), one-bit or multi-bit (e.g., 2-bit) indicator that represents the reference unified TCI state among all the indicated (e.g., N>1 or M>1) unified TCI states (indicated in the beam indication DCI or MAC CE as specified herein in the present disclosure) and/or etc., when the reference unified TCI state is signalled/indicated/provided/configured to the UE via various signalling mediums such as RRC and/or MAC CE and/or DCI for various channels/signals such as PDCCH, PDSCH, PUCCH and/or PUSCH. For instance, when/if the reference unified TCI state is signalled/represented via a 2-bit indicator, both of the indicated TCI states (i.e., N=2 or M=2) could be used/applied for (simultaneous) reception of PDCCH, reception of PDSCH, transmission of PUCCH and/or transmission of PUSCH.

Furthermore (e.g., in one beam indication instance), the (exact) reference unified TCI state—e.g., the TCI state ID of the reference unified TCI state—could be common for all channels/signals such as PDCCH, PDSCH, PUCCH and PUSCH, or different for one or more of the DL/UL channels/signals such as PDCCH, PDSCH, PUCCH and/or PUSCH. For PDCCH reception (e.g., in one beam indication instance), the (exact) reference unified TCI state—e.g., the TCI state ID of the reference unified TCI state—could be common for all sDCI CORESETs as specified herein in the present disclosure, or different for one or more of the sDCI CORESETs as specified herein in the present disclosure.

In one embodiment, various methods of applying the indicated Rel. 17 unified TCI state(s) in a sDCI based multi-TRP system and the corresponding HARQ-ACK transmission corresponding to the DCI carrying the unified TCI state indication are provided.

As discussed above, the UE could be indicated by the network, e.g., via a codepoint in the “transmission configuration indication” field in a DCI format (e.g., DCI format 1_1 or 1_2 with or without DL assignment), M>1 or N>1 Rel. 17 unified TCI states. Furthermore, for the sDCI based multi-TRP system considered in the present disclosure, the QCL assumption(s) for the sDCI CORESET(s) or the Type-1 sDCI CORESET(s) could follow the QCL source RS(s) and the corresponding QCL type(s) indicated in the reference Rel. 17 unified TCI state. The determination of the reference Rel. 17 unified TCI state from the M>1 or N>1 indicated Rel. 17 unified TCI states could follow those specified in examples provided in the present disclosure.

Depending on whether the indicated reference Rel. 17 unified TCI state is different from the previously indicated one, the UE may or may not transmit a PUCCH with HARQ-ACK information corresponding to the DCI carrying the M>1 or N>1 Rel. 17 unified TCI states.

In one example, the UE may transmit a PUCCH with HARQ-ACK information corresponding to the DCI carrying the M>1 or N>1 Rel. 17 unified TCI states when only the indicated reference Rel. 17 unified TCI state is different from the previously indicated one.

In another example, the UE may transmit a PUCCH with HARQ-ACK information corresponding to the DCI carrying the M>1 or N>1 Rel. 17 unified TCI states when at least the indicated reference Rel. 17 unified TCI state is different from the previously indicated one.

In yet another example, the UE may transmit a PUCCH with HARQ-ACK information corresponding to the DCI carrying the M>1 or N>1 Rel. 17 unified TCI states when one or more of the indicated M>1 or N>1 Rel. 17 unified TCI states are different from the previously indicated ones.

In yet another example, the UE may not transmit a PUCCH with HARQ-ACK information corresponding to the DCI carrying the M>1 or N>1 Rel. 17 unified TCI states when the indicated reference Rel. 17 unified TCI state is the same from the previously indicated one.

When only the indicated reference Rel. 17 unified TCI state—determined from the M>1 or N>1 Rel. 17 unified TCI states indicated in the DCI (e.g., DCI format 1_1 or 1_2 with or without DL assignment) according to examples provided in the present disclosure—is different from the previously indicated one of following examples.

In one example, when the UE may transmit the last symbol of the PUCCH with HARQ-ACK information corresponding to the DCI carrying the M>1 or N>1 Rel. 17 unified TCI states indication and without DL assignment, the indicated M>1 or N>1 Rel. 17 unified TCI states, or more specifically, the indicated reference Rel. 17 unified TCI state that is different from the previously indicated one, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In another example, when the UE may receive the first (or the last) symbol of the PDCCH/DCI carrying the M>1 or N>1 Rel. 17 unified TCI states indication (with or without DL assignment), the indicated M>1 or N>1 Rel. 17 unified TCI states, or more specifically, the indicated reference Rel. 17 unified TCI state that is different from the previously indicated one, may be applied starting from the first slot that is at least BeamAppTime_r17 (beam application time—BAT) symbols after the first (or the last) symbol of the PDCCH/DCI for unified TCI state indication. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to PDSCH(s) scheduled by the DCI carrying the M>1 or N>1 Rel. 17 unified TCI states indication, the indicated M>1 or N>1 Rel. 17 unified TCI states, or more specifically, the indicated reference Rel. 17 unified TCI state that is different from the previously indicated one, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state, the indicated M>1 or N>1 Rel. 17 unified TCI states, or more specifically, the indicated reference Rel. 17 unified TCI state that is different from the previously indicated one, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state other than the reference Rel. 17 unified TCI state, the indicated M>1 or N>1 Rel. 17 unified TCI states, or more specifically, the indicated reference Rel. 17 unified TCI state that is different from the previously indicated one, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication. The second PDSCH(s) whose DM-RS antenna ports are quasi co-located with reference signals provided in the indicated Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

In yet another example, when the UE may transmit the last symbol of the PUCCH with HARQ-ACK information corresponding to the first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state or the second PDSCH(s)—scheduled by the DCI carrying the M>1 or N>1 Rel. 17 unified TCI states indication —whose DM-RS antenna ports are quasi co-located with reference signals provided in an indicated Rel. 17 unified TCI state other than the reference Rel. 17 unified TCI state (e.g., the first PDSCH(s) or the second PDSCH(s) that ends later in time), the indicated M>1 or N>1 Rel. 17 unified TCI states, or more specifically, the indicated reference Rel. 17 unified TCI state that is different from the previously indicated one, may be applied starting from the first slot that is at least BeamAppTime_r17 (beam application time—BAT) symbols after the last symbol of the PUCCH.

The first slot and the BAT provided by the higher layer parameter BeamAppTime_r17 symbols are both determined on the carrier with the smallest subcarrier spacing (SCS) among the carrier(s) applying the beam indication. The second PDSCH(s) whose DM-RS antenna ports are quasi co-located with reference signals provided in the indicated Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

In yet another example, when the UE may transmit the last symbol of the PUCCH with HARQ-ACK information corresponding to the first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state or the second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state other than the reference Rel. 17 unified TCI state (e.g., the first PDSCH(s) or the second PDSCH(s) that ends earlier in time), the indicated M>1 or N>1 Rel. 17 unified TCI states, or more specifically, the indicated reference Rel. 17 unified TCI state that is different from the previously indicated one, may be applied starting from the first slot that is at least BeamAppTime_r17 (beam application time—BAT) symbols after the last symbol of the PUCCH.

The first slot and the BAT provided by the higher layer parameter BeamAppTime_r17 symbols are both determined on the carrier with the smallest subcarrier spacing (SCS) among the carrier(s) applying the beam indication. The second PDSCH(s) whose DM-RS antenna ports are quasi co-located with reference signals provided in the indicated Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

When one or more indicated Rel. 17 unified TCI states not including the reference Rel. 17 unified TCI state are different from their corresponding previously indicated ones, wherein the one or more indicated Rel. 17 unified TCI states not including the reference Rel. 17 unified TCI state are referred to as second Rel. 17 unified TCI states in the present disclosure, and the reference Rel. 17 unified TCI state is determined from the M>1 or N>1 Rel. 17 unified TCI states indicated in the DCI (e.g., DCI format 1_1 or 1_2 with or without DL assignment) according to examples provided in the present disclosure.

In one example, when the UE may transmit the last symbol of the PUCCH with HARQ-ACK information corresponding to the DCI carrying the M>1 or N>1 Rel. 17 unified TCI states indication and without DL assignment, the indicated M>1 or N>1 Rel. 17 unified TCI states, or more specifically, the indicated second Rel. 17 unified TCI states that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In another example, when the UE may receive the first (or the last) symbol of the PDCCH/DCI carrying the M>1 or N>1 Rel. 17 unified TCI states indication (with or without DL assignment), the indicated M>1 or N>1 Rel. 17 unified TCI states, or more specifically, the indicated second Rel. 17 unified TCI states that are different from their corresponding previously indicated ones, may be applied starting from the first slot that is at least BeamAppTime_r17 (beam application time—BAT) symbols after the first (or the last) symbol of the PDCCH/DCI for unified TCI state indication. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to PDSCH(s) scheduled by the DCI carrying the M>1 or N>1 Rel. 17 unified TCI states indication, the indicated M>1 or N>1 Rel. 17 unified TCI states, or more specifically, the indicated second Rel. 17 unified TCI states that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state, the indicated M>1 or N>1 Rel. 17 unified TCI states, or more specifically, the indicated second Rel. 17 unified TCI states that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state or an indicated second Rel. 17 unified TCI state other than the reference Rel. 17 unified TCI state, the indicated M>1 or N>1 Rel. 17 unified TCI states, or more specifically, the indicated second Rel. 17 unified TCI states that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

The second PDSCH(s) whose DM-RS antenna ports are quasi co-located with reference signals provided in the indicated Rel. 17 unified TCI state or in the indicated second Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states or one or more other indicated second Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

In yet another example, when the UE may transmit the last symbol of the PUCCH with HARQ-ACK information corresponding to the first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state or the second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state or an indicated second Rel. 17 unified TCI state other than the reference Rel. 17 unified TCI state (e.g., the first PDSCH(s) or the second PDSCH(s) that ends later in time), the indicated M>1 or N>1 Rel. 17 unified TCI states, or more specifically, the indicated second Rel. 17 unified TCI states that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

The second PDSCH(s) whose DM-RS antenna ports are quasi co-located with reference signals provided in the indicated Rel. 17 unified TCI state or the indicated second Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states or one or more other indicated second Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

In yet another example, when the UE may transmit the last symbol of the PUCCH with HARQ-ACK information corresponding to the first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state or the second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state or an indicated second Rel. 17 unified TCI state other than the reference Rel. 17 unified TCI state (e.g., the first PDSCH(s) or the second PDSCH(s) that ends earlier in time), the indicated M>1 or N>1 Rel. 17 unified TCI states, or more specifically, the indicated second Rel. 17 unified TCI states that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

The second PDSCH(s) whose DM-RS antenna ports are quasi co-located with reference signals provided in the indicated Rel. 17 unified TCI state or the indicated second Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states or one or more other indicated second Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

When one or more indicated Rel. 17 unified TCI states including the reference Rel. 17 unified TCI state are different from their corresponding previously indicated ones, wherein the indicated Rel. 17 unified TCI states not including the reference Rel. 17 unified TCI state are referred to as second Rel. 17 unified TCI states in the present disclosure, and the reference Rel. 17 unified TCI state is determined from the M>1 or N>1 Rel. 17 unified TCI states indicated in the DCI (e.g., DCI format 1_1 or 1_2 with or without DL assignment) according to examples provided in the present disclosure, the one or more indicated Rel. 17 unified TCI states including the second Rel. 17 unified TCI states and the reference Rel. 17 unified TCI state are applied according to a common BAT.

In one example, when the UE may transmit the last symbol of the PUCCH with HARQ-ACK information corresponding to the DCI carrying the M>1 or N>1 Rel. 17 unified TCI states indication and without DL assignment, the indicated M>1 or N>1 Rel. 17 unified TCI states, or more specifically, the indicated second Rel. 17 unified TCI states and the reference Rel. 17 unified TCI state that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In another example, when the UE may receive the first (or the last) symbol of the PDCCH/DCI carrying the M>1 or N>1 Rel. 17 unified TCI states indication (with or without DL assignment), the indicated M>1 or N>1 Rel. 17 unified TCI states, or more specifically, the indicated second Rel. 17 unified TCI states and the reference Rel. 17 unified TCI state that are different from their corresponding previously indicated ones, may be applied starting from the first slot that is at least BeamAppTime_r17 (beam application time—BAT) symbols after the first (or the last) symbol of the PDCCH/DCI for unified TCI state indication. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to PDSCH(s) scheduled by the DCI carrying the M>1 or N>1 Rel. 17 unified TCI states indication, the indicated M>1 or N>1 Rel. 17 unified TCI states, or more specifically, the indicated second Rel. 17 unified TCI states and the reference Rel. 17 unified TCI state that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state, the indicated M>1 or N>1 Rel. 17 unified TCI states, or more specifically, the indicated second Rel. 17 unified TCI states and the reference Rel. 17 unified TCI state that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

In yet another example, when the UE may transmit the last symbol of the PUCCH with HARQ-ACK information corresponding to second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state or an indicated second Rel. 17 unified TCI state other than the reference Rel. 17 unified TCI state, the indicated M>1 or N>1 Rel. 17 unified TCI states, or more specifically, the indicated second Rel. 17 unified TCI states and the reference Rel. 17 unified TCI state that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

The second PDSCH(s) whose DM-RS antenna ports are quasi co-located with reference signals provided in the indicated Rel. 17 unified TCI state or in the indicated second Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states or one or more other indicated second Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

In yet another example, when the UE may transmit the last symbol of the PUCCH with HARQ-ACK information corresponding to the first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state or the second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state or an indicated second Rel. 17 unified TCI state other than the reference Rel. 17 unified TCI state (e.g., the first PDSCH(s) or the second PDSCH(s) that ends later in time), the indicated M>1 or N>1 Rel. 17 unified TCI states, or more specifically, the indicated second Rel. 17 unified TCI states and the reference Rel. 17 unified TCI state that are different from their corresponding previously indicated ones, may be applied starting from the first slot that is at least BeamAppTime_r17 (beam application time—BAT) symbols after the last symbol of the PUCCH.

The first slot and the BAT provided by the higher layer parameter BeamAppTime_r17 symbols are both determined on the carrier with the smallest subcarrier spacing (SCS) among the carrier(s) applying the beam indication. The second PDSCH(s) whose DM-RS antenna ports are quasi co-located with reference signals provided in the indicated Rel. 17 unified TCI state or the indicated second Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states or one or more other indicated second Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

In yet another example, when the UE may transmit the last symbol of the PUCCH with HARQ-ACK information corresponding to the first PDSCH(s)—scheduled by the DCI carrying the M>1 or N>1 Rel. 17 unified TCI states indication—whose DM-RS antenna ports are quasi co-located with reference signals provided in the reference Rel. 17 unified TCI state or the second PDSCH(s)—scheduled by the DCI carrying the M>1 or N>1 Rel. 17 unified TCI states indication—whose DM-RS antenna ports are quasi co-located with reference signals provided in an indicated Rel. 17 unified TCI state or an indicated second Rel. 17 unified TCI state other than the reference Rel. 17 unified TCI state (e.g., the first PDSCH(s) or the second PDSCH(s) that ends earlier in time), the indicated M>1 or N>1 Rel. 17 unified TCI states, or more specifically, the indicated second Rel. 17 unified TCI states and the reference Rel. 17 unified TCI state that are different from their corresponding previously indicated ones, may be applied starting from the first slot that is at least BeamAppTime_r17 (beam application time—BAT) symbols after the last symbol of the PUCCH. The first slot and the BAT provided by the higher layer parameter BeamAppTime_r17 symbols are both determined on the carrier with the smallest subcarrier spacing (SCS) among the carrier(s) applying the beam indication.

The second PDSCH(s) whose DM-RS antenna ports are quasi co-located with reference signals provided in the indicated Rel. 17 unified TCI state or the indicated second Rel. 17 unified TCI state other than the reference Rel. 17 unified TCI state could end later or earlier in time than PDSCH(s) whose DM-RS antenna ports are quasi co-located with reference signals provided in one or more other indicated Rel. 17 unified TCI states or one or more other indicated second Rel. 17 unified TCI states other than the reference Rel. 17 unified TCI state. For M=2 or N=2, the DM-RS antenna ports for receiving the second PDSCH(s) are quasi co-located with reference signals provided in the indicated Rel. 17 unified TCI state other than the reference Rel. 17 unified TCI state.

When one or more indicated Rel. 17 unified TCI states including the reference Rel. 17 unified TCI state are different from their corresponding previously indicated ones, wherein the indicated Rel. 17 unified TCI states not including the reference Rel. 17 unified TCI state are referred to as second Rel. 17 unified TCI states in the present disclosure, and the reference Rel. 17 unified TCI state is determined from the M>1 or N>1 Rel. 17 unified TCI states indicated in the DCI (e.g., DCI format 1_1 or 1_2 with or without DL assignment) according to examples provided in the present disclosure, the second Rel. 17 unified TCI states and the reference Rel. 17 unified TCI state could be applied according to separate BATs.

In one example, the indicated reference Rel. 17 unified TCI state is applied according to those specified in examples provided in the present disclosure, and the indicated second Rel. 17 unified TCI states are applied according to one or more of examples provided in the presented disclosure.

In another example, the indicated reference Rel. 17 unified TCI state is applied according to those specified in example provided in the present disclosure, and the indicated second Rel. 17 unified TCI states are applied according to one or more of examples provided in the present disclosure.

In one example, the indicated reference Rel. 17 unified TCI state is applied according to those specified in examples provided in the present disclosure, and the indicated second Rel. 17 unified TCI states are applied according to one or more of examples provided in the present disclosure.

In one example, the indicated reference Rel. 17 unified TCI state is applied according to those specified in examples provided in the present disclosure, and the indicated second Rel. 17 unified TCI states are applied according to one or more of examples provided in the present disclosure.

In one example, the indicated reference Rel. 17 unified TCI state is applied according to those specified in example provided in the present disclosure, and the indicated second Rel. 17 unified TCI states are applied according to one or more of examples provided in the present disclosure.

In one example, the indicated reference Rel. 17 unified TCI state is applied according to those specified in examples provided in the present disclosure, and the indicated second Rel. 17 unified TCI states are applied according to one or more of examples provided in the present disclosure.

In one example, the indicated reference Rel. 17 unified TCI state is applied according to those specified in examples provided in the present disclosure, and the indicated second Rel. 17 unified TCI states are applied according to one or more of examples provided in the present disclosure.

In one embodiment, various methods of using the indicated reference Rel. 17 unified TCI state for cross-carrier beam indication are provided.

In the present disclosure, a carrier could correspond to a cell or a BWP or a component carrier or a frequency band or a frequency range. The carrier in which the UE receives the MAC CE or DCI format (e.g., DCI format 1_1 or 1_2 with or without DL assignment) indicating the one or more (e.g., M>1 or N>1) Rel. 17 unified TCI states could be referred to as the self/serving carrier or own carrier.

A UE could receive in the self/serving carrier via MAC CE or DCI (e.g., DCI format 1_1 or 1_2 with or without DL assignment) based signaling one or more (e.g., N>1 or M>1) Rel. 17 unified TCI states for the self/serving carrier and at least one carrier different from the self/serving carrier. In one example, the MAC CE or DCI for unified TCI state indication could include/contain one or more “carrier indicator” fields. A “carrier indicator” field could indicate one or more (e.g., K≥1) carriers or carrier indexes. Alternatively, a “transmission configuration indication” field in the MAC CE or DCI for unified TCI state indication could contain/include/indicate one or more (e.g., K≥1) carriers or carrier indexes. Each of the indicated K≥1 carriers or carrier indexes could correspond/map to at least one Rel. 17 unified TCI state among the N>1 or M>1 Rel. 17 unified TCI states indicated in the MAC CE or DCI for unified TCI state indication.

Throughout the present disclosure, a carrier j different from the self/serving carrier is considered. The carrier j or the carrier index of the carrier j could be indicated in a “carrier indicator” field or a “transmission configuration indication” field in the MAC CE or DCI for unified TCI state indication received in the self/serving carrier. As discussed above, the UE could be provided by the network in the self/serving carrier via MAC CE or DCI (e.g., DCI format 1_1 or 1_2 with or without DL assignment) based signaling N>1 or M>1 Rel. 17 unified TCI states for the sDCI based multi-TRP operation with the reference Rel. 17 unified TCI state determined from the M>1 or N>1 Rel. 17 unified TCI states indicated in the DCI (e.g., DCI format 1_1 or 1_2 with or without DL assignment) according to examples provided in the present disclosure.

For this case, DM-RS antenna ports for PDCCH receptions in one or more CORESETs in the carrier j, DM-RS antenna ports for PDSCH receptions in the carrier j, receive filter(s) for receiving one or more CSI-RS resources in the carrier j, or transmit filter(s) for transmitting dynamic-grant/configured-grant based PUSCH, all of dedicated PUCCH resources or one or more SRS resources in the carrier j, could be quasi co-located with or spatially related to the reference signal provided in the indicated reference Rel. 17 unified TCI state.

DM-RS antenna ports for PDCCH receptions in one or more CORESETs in the carrier j may or may not be quasi co-located with the reference signal provided in the reference Rel. 17 unified TCI state. In the present disclosure, the control resource set(s) in the carrier j whose QCL assumption(s) follow that provided in the indicated reference Rel. 17 unified TCI state is referred to as Type-1 CORESET(s) in the carrier j, while the control resource set(s) in the carrier j whose QCL assumption(s) does not follow that provided in the indicated reference Rel. 17 unified TCI state is referred to as Type-2 CORESET(s) in the carrier j. Furthermore, a Type-1 CORESET in the carrier j or a Type-2 CORESET in the carrier j could correspond to one or more of examples.

In one example of “CORESET A”: a CORESET other than CORESET with index 0 (or CORESET #0) associated with only UE-dedicated PDCCH reception(s) in a CC, comprising, e.g., CORESET(s) associated with USS set(s) or Type3-PDCCH CSS set(s).

In one example of “CORESET B”: a CORESET other than CORESET #0 associated with only non-UE-dedicated PDCCH reception(s) in a CC, comprising, e.g., CORESET(s) associated with all types of CSS sets such as Type0/0A/1/2/3-PDCCH CSS sets or CSS sets other than Type3-PDCCH CSS set(s) such as Type0/0A/1/2-PDCCH CSS sets.

In one example of “CORESET C”: a CORESET other than CORESET #0 associated with both UE-dedicated and non-UE-dedicated PDCCH receptions in a CC.

In one example, CORESET #0, i.e., CORESET with index 0.

The UE could be provided/configured with “useIndicatedr17TCIState” for one or more of the Type-1 CORESETs in the carrier j. For instance, the UE could be provided/configured with “useIndicatedr17TCIstate” set to “enabled” in the parameter, e.g., the higher layer parameter ControlResourceSet, that configures the corresponding Type-1 CORESET(s) in a carrier (e.g., the carrier j) different from the self/serving carrier.

Furthermore, the UE could also be provided/configured with “useIndicatedr17TCIState” for one or more CSI-RS resources/CSI resource sets/CSI resource settings or one or more SRS resources/SRS resource sets/SRS resource settings. For this case, DM-RS antenna ports for PDCCH receptions in one or more Type-1 CORESETs in the carrier j, DM-RS antenna ports for PDSCH receptions in the carrier j, receive filter(s) for receiving one or more CSI-RS resources configured with “useIndicatedr17TCIState” in the carrier j, or transmit filter(s) for transmitting dynamic-grant/configured-grant based PUSCH, all of dedicated PUCCH resources or one or more SRS resources configured with “useIndicatedr17TCIState” in the carrier j, could be quasi co-located with or spatially related to the reference signal provided in the indicated reference Rel. 17 unified TCI state.

In a multiple TRP system depicted in FIG. 8, the UE could simultaneously receive from multiple physically non-co-located TRPs various channels/RSs such as PDCCHs and/or PDSCHs using either a single RX panel or multiple RX panels. In this disclosure, a RX panel could correspond to a set of RX antenna elements/ports at the UE, a set of measurement RS resources such as SRS resources, a spatial domain RX filter or etc. Further, a TRP in the multi-TRP system can represent a collection of measurement antenna ports, measurement RS resources and/or CORESETs.

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and (5) a plurality of CORESETs associated with a TRP-specific index/indicator/identity.

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation considered in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI or a different PCI (with respect to the serving cell PCI).

Furthermore, in a wireless communications system, a radio link failure (RLF) could occur if a significant/sudden link quality drop is observed at the UE side. If a RLF occurs, fast RLF recovery mechanisms, therefore, become essential to promptly re-establish the communication link(s) and avoid severe service interruption. At higher frequencies, e.g., millimeter-wave (mmWave) frequencies or frequency range 2 (FR 2) in the 3GPP NR, both the transmitter and receiver could use directional (analog) beams to transmit and receive various RSs/channels such as SSBs, CSI-RSs, PDCCHs or PDSCHs. Hence, prior to declaring a full RLF, the UE could first detect and recover a potential beam failure if the signal qualities/strengths of certain beam pair links (BPLs) are below a certain threshold for a certain period of time.

FIG. 9 illustrates an example of a BFR procedure 900 according to embodiments of the present disclosure. The embodiment of the BFR procedure 900 illustrated in FIG. 9 is for illustration only.

The 3GPP Rel. 15 BFR procedure mainly targets for a primary cell (PCell or PSCell) under the carrier aggregation (CA) framework as illustrated in FIG. 9. The BFR procedure in the 3GPP Rel. 15 comprises the following key components: (1) a beam failure detection (BFD); (2) a new beam identification (NBI); (3) a BFR request (BFRQ); and (4) a BFRQ response (BFRR).

The UE is first configured by the gNB a set of BFD RS resources to monitor the link qualities between the gNB and the UE. One BFD RS resource could correspond to one (periodic) CSI-RS/SSB RS resource, which could be a QCL source RS with typeD in a TCI state for a CORESET. If the received signal qualities of all the BFD RS resources are below a given threshold (implying that the hypothetical BLERs of the corresponding CORESETs/PDCCHs are above a given threshold), the UE could declare a beam failure instance (BFI). Furthermore, if the UE has declared N_BFI consecutive BFIs within a given time period, the IE may declare a beam failure.

After declaring/detecting the beam failure, the UE may transmit the BFRQ to the gNB via a contention-free (CF) PRACH (CF BFR-PRACH) resource, whose index is associated with a new beam identified by the UE. Specifically, to determine a potential new beam, the UE could be first configured by the network a set of SSB and/or CSI-RS resources (NBI RS resources) via a higher layer parameter candidateBeamRSList. The UE may then measure the NBI RSs and calculate their L1-RSRPs. If at least one of the measured L1-RSRPs of the NBI RSs is beyond a given threshold, the UE may select the beam that corresponds to the NBI RS with the highest L1-RSRP as the new beam q_new. To determine a CF BFR-PRACH resource to convey the BFRQ, the UE could be first configured by the network a set of PRACH resources, each associated with a NBI RS resource. The UE could then select the PRACH resource that has the one-to-one correspondence to the selected NBI RS resource (and therefore, the new beam index q_new) to send the BFRQ to the gNB. From the index of the selected CF PRACH resource, the gNB could also know which beam is selected by the UE as the new beam.

Four slots after the UE has transmitted the BFRQ, the UE could start to monitor a dedicated CORESET/search space for BFRQ response. The dedicated CORESET is addressed to the UE-specific C-RNTI, and may be transmitted by the gNB using the newly identified beam. If the UE detects a valid UE-specific DCI in the dedicated CORESET for BFRR, the UE may assume that the beam failure recovery request has been successfully received by the network, and the UE may complete the BFR process. Otherwise, if the UE does not receive the BFRR within a configured time window, the UE may initiate a contention based (CB) RA process to reconnect to the network.

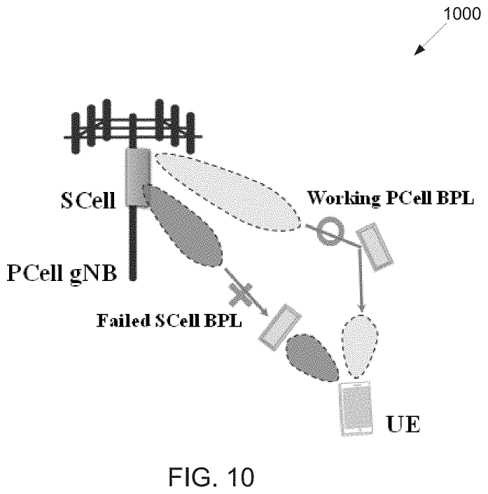

FIG. 10 illustrates another example of a BFR procedure 1000 according to embodiments of the present disclosure. The embodiment of the BFR procedure 1900 illustrated in FIG. 10 is for illustration only.

In the 3GPP Rel. 16, the BFR procedures were customized for the secondary cell (SCell) under the CA framework, in which the BPL(s) between the PCell and the UE is assumed to be working. An illustrative example of the SCell beam failure is given in FIG. 10.

After declaring/detecting the beam failure for the SCell, the UE may transmit the BFRQ in form of a scheduling request (SR) over a PUCCH for the working PCell. Furthermore, the UE could only transmit the BFRQ at this stage without indicating any new beam index, failed SCell index or other information to the network. This is different from the Rel. 15 PCell/PSCell procedure, in which the UE may indicate both the BFRQ and the identified new beam index to the network at the same time. Allowing the gNB to quickly know the beam failure status of the SCell without waiting for the UE to identify a new beam could be beneficial. For instance, the gNB could deactivate the failed SCell and allocate the resources to other working SCells.

The UE could be indicated by the network an uplink grant in response to the BFRQ SR, which may allocate necessary resources for the MAC CE to carry new beam index q_new (if identified), failed SCell index and etc. over the PUSCH for the working PCell. After transmitting the MAC CE for BFR to the working PCell, the UE may start to monitor the BFRR. The BFRR could be a TCI state indication for a CORESET for the corresponding SCell. The BFRR to the MAC CE for BFR could also be a normal uplink grant for scheduling a new transmission for the same HARQ process as the PUSCH carrying the MAC CE for BFR. If the UE could not receive the BFRR within a configured time window, the ULE could transmit BFR-PUCCH again, or fall back to CBRA process.

A UE can be provided, for each BWP of a serving cell, a set q̅₀ of periodic CSI-RS resource configuration indexes by failureDetectionResourcesToAddModList and a set q̅₁ of periodic CSI-RS resource configuration indexes and/or SS/PBCH block indexes by candidateBeamRSList or candidateBeamRSListExt or candidateBeamRSSCellList for radio link quality measurements on the BWP of the serving cell. In the present disclosure, in a single-TRP system or for single-TRP operation, a BFD RS (beam) set could correspond to the set q̅₀ described herein, and a NBI RS (beam) set could correspond to the set q̅₁ described herein.

Instead of the sets q̅₀ and q̅₁, for each BWP of a serving cell, the UE can be provided respective two sets q̅_{0,0} and q̅_{0,1} of periodic CSI-RS resource configuration indexes that can be activated by a MAC CE [11 TS 38.321] and corresponding two sets q̅_{1,0} and q̅_{1,1} of periodic CSI-RS resource configuration indexes and/or SS/PBCH block indexes by candidateBeamRSList1 and candidateBeamRSList2, respectively, for radio link quality measurements on the BWP of the serving cell. The set q̅_{0,0} is associated with the set q̅_{1,0} and the set q̅_{0,1} is associated with the set q̅_{1,1}. In the present disclosure, in a multi-TRP system or for multi-TRP operation, the UE can be provided a BFD RS (beam) set p, where p∈{1, 2, . . . , N} and N denotes the total number of BFD RS (beam) sets configured/provided to the UE. For this case, the first BFD RS set or BFD RS set 1 (e.g., p=1) could correspond to the set q̅_{0,0} described herein, and the second BFD RS set or BFD RS set 2 (e.g., p=2) could correspond to the set q̅_{0,1} described herein. In addition, the UE can be provided a NBI RS (beam) set p′, where p′∈{1, 2, . . . , M} and M denotes the total number of NBI RS (beam) sets configured/provided to the UE. For this case, the first NBI RS set or NBI RS set 1 (e.g., p′=1) could correspond to the set q̅_{1,0} described herein, and the second NBI RS set or NBI RS set 2 (e.g., p′=2) could correspond to the set q̅_{1,1} described herein.

If the UE is not provided q̅₀ by failureDetectionResourcesToAddModList for a BWP of the serving cell, the UE determines the set q̅₀ to include periodic CSI-RS resource configuration indexes with same values as the RS indexes in the RS sets indicated by TCI-State for respective CORESETs that the UE uses for monitoring PDCCH. If the UE is not provided q̅_{0,0} or q̅₀, for a BWP of the serving cell, the UE determines the set q̅_{0,0} or q̅_{0,1} to include periodic CSI-RS resource configuration indexes with same values as the RS indexes in the RS sets indicated by TCI-State for first and second CORESETs that the UE uses for monitoring PDCCH, where the UE is provided two coresetPoolIndex values 0 and 1 for the first and second CORESETs, or is not provided coresetPoolIndex value for the first CORESETs and is provided coresetPoolIndex value of 1 for the second CORESETs, respectively. If there are two RS indexes in a TCI state, the set q̅₀ or q̅_{0,0}, or q̅_{0,1} includes RS indexes configured with qcl-Type set to ‘typeD’ for the corresponding TCI states. In the present disclosure, in a single-TRP system or for single-TRP operation, a BFD RS (beam) set could correspond to the set q̅₀ described herein, and a NBI RS (beam) set could correspond to the set q̅₁ described herein. In the present disclosure, in a multi-TRP system or for multi-TRP operation, the UE can be provided a BFD RS (beam) set p, where p∈{1, 2, . . . , N} and N denotes the total number of BFD RS (beam) sets configured/provided to the UE. For this case, the first BFD RS set or BFD RS set 1 (e.g., p=1) could correspond to the set q̅_{0,0} described herein, and the second BFD RS set or BFD RS set 2 (e.g., p=2) could correspond to the set q̅_{0,1} described herein. In addition, the UE can be provided a NBI RS (beam) set p′, where p′∈{1, 2, . . . , M} and M denotes the total number of NBI RS (beam) sets configured/provided to the UE. For this case, the first NBI RS set or NBI RS set 1 (e.g., p′=1) could correspond to the set q̅₁₀ described herein, and the second NBI RS set or NBI RS set 2 (e.g., p′=2) could correspond to the set q̅_{1,1} described herein.

If a CORESET that the UE uses for monitoring PDCCH includes two TCI states and the UE is provided sfnSchemePdcch set to ‘sfnSchemeA’ or ‘sfnSchemeB’, the set q̅₀ includes RS indexes in the RS sets associated with the two TCI states. The UE expects the set q̅₀ to include up to two RS indexes. If the UE is provided q̅_{0,0} or q̅_{0,1}, the UE expects the set q̅_{0,0} or the set q̅_{0,1} to include up to a number of N_{BFD} RS indexes indicated by capabilityparametername. If the UE is not provided q̅_{0,0} or q̅_{0,1}, and if a number of active TCI states for PDCCH receptions in the first or second CORESETs is larger than N_{BFD}, the UE determines the set q̅_{0,0} or q̅_{0,1} to include periodic CSI-RS resource configuration indexes with same values as the RS indexes in the RS sets associated with the active TCI states for PDCCH receptions in the first or second CORESETs corresponding to search space sets according to an ascending order for monitoring periodicity. If more than one first or second CORESETs correspond to search space sets with same monitoring periodicity, the UE determines the order of the first or second CORESETs according to a descending order of a CORESET index.

If a UE is not provided coresetPoolIndex or is provided coresetPoolIndex with a value of 0 for first CORESETs on an active DL BWP of a serving cell, and/or the UE is provided coresetPoolIndex with a value of 1 for second CORESETs on the active DL BWP of the serving cells, and/or the UE is provided SSB-MTCAdditionalPCI, SS/PBCH block indexes associated with a physical cell identity other than the one provided by physCellId in ServingCellConfigCommon can be provided in either q̅_{1,0} or q̅_{1,1} set and the corresponding q̅_{0,0} or q̅₀, set is associated with the physical cell identity.

The UE expects single port RS in the set q̅₀, or q̅_{0,0}, or q̅_{0,1}. The UE expects single-port or two-port CSI-RS with frequency density equal to 1 or 3 REs per RB in the set q̅₁, or q̅_{1,0}, or q̅_{1,1}. The thresholds Q_{out,LR} and Q_{in,LR} correspond to the default value of rlmInSyncOutOfSyncThreshold, as described in [10, TS 38.133] for Qₒᵤₜ, and to the value provided by rsrp-ThresholdSSB or rsrp-ThresholdBFR, respectively.

The physical layer in the UE assesses the radio link quality according to the set q̅₀, q̅_{0,0}, or q̅_{0,1}, of resource configurations against the threshold Q_{out,LR}. For the set q̅₀, the UE assesses the radio link quality only according to SS/PBCH blocks on the PCell or the PSCell or periodic CSI-RS resource configurations that are quasi co-located, as described in [6, TS 38.214], with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

In non-DRX mode operation, the physical layer in the UE provides an indication to higher layers when the radio link quality for all corresponding resource configurations in the set q̅₀, or in the set q̅_{0,0} or q̅₀, that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀, q̅_{0,0}, or q̅_{0,1} that the UE uses to assess the radio link quality and 2 msec. In DRX mode operation, the physical layer provides an indication to higher layers when the radio link quality is worse than the threshold Q_{out,LR} with a periodicity determined as described in [10, TS 38.133].

For the PCell or the PSCell, upon request from higher layers, the UE provides to higher layers the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold.

For the SCell, upon request from higher layers, the UE indicates to higher layers whether there is at least one periodic CSI-RS configuration index or SS/PBCH block index from the set q̅₁, or q̅_{1,0}, or q̅_{1,1}, with corresponding L1-RSRP measurements that is larger than or equal to the Q_{in,LR} threshold, and provides the periodic CSI-RS configuration indexes and/or SS/PBCH block indexes from the set q̅₁, or q̅_{1,0}, or q̅_{1,1}, and the corresponding L1-RSRP measurements that are larger than or equal to the Q_{in,LR} threshold, if any.

For the PCell or the PSCell, a UE can be provided a CORESET through a link to a search space set provided by recoverySearchSpaceId, as described in clause 10.1, for monitoring PDCCH in the CORESET. If the UE is provided recoverySearchSpaceId, the UE does not expect to be provided another search space set for monitoring PDCCH in the CORESET associated with the search space set provided by recoverySearchSpaceId.

For the PCell or the PSCell, the UE can be provided, by PRACH-ResourceDedicatedBFR, a configuration for PRACH transmission as described in clause 8.1. For PRACH transmission in slot n and according to antenna port quasi co-location parameters associated with periodic CSI-RS resource configuration or with SS/PBCH block associated with index q_{new} provided by higher layers [11, TS 38.321], the UE monitors PDCCH in a search space set provided by recoverySearchSpaceId for detection of a DCI format with CRC scrambled by C-RNTI or MCS-C-RNTI starting from slot n+4+2^{μ}·k_{mac}, where y is the SCS configuration for the PRACH transmission and k_{mac} is a number of slots provided by K-Mac [12, TS 38.331] or k_{mac}=0 if K-Mac is not provided, within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

Under Rel. 17 unified transmission configuration indication (TCI) framework, beam indication for the multi-TRP operation needs to be specified. Especially for a single-DCI (sDCI) based multi-TRP system, solutions for associating an indicated Rel. 17 unified TCI state to one or more PDCCH transmissions, beam failure recovery, and beam measurement and reporting are needed. The unified TCI framework can be according to those specified herein in the present disclosure.

The present disclosure provides various design aspects related to beam management including beam indication, beam failure recovery and beam measurement/reporting for single-DCI based multi-TRP operation under the Rel. 17 unified TCI state framework.

As described in the U.S. patent application Ser. No. 17/584,239 incorporated by reference in its entirety, a unified TCI framework could indicate/include N>1 DL TCI states and/or M>1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; and (4) separate DL TCI state and UL TCI state and/or their corresponding/associated TCI state ID(s).

There could be various design options/channels to indicate to the UE a beam (i.e., a TCI state) for the transmission/reception of a PDCCH or a PDSCH. As described in the U.S. patent application Ser. No. 17/584,239 incorporated by reference in its entirety, following examples can be provided.

In one example, a MAC CE could be used to indicate to the UE a beam (i.e., a TCI state and/or a TCI state ID) for the transmission/reception of a PDCCH or a PDSCH.

In another example, a DCI could be used to indicate to the UE a beam (i.e., a TCI state and/or a TCI state ID) for the transmission/reception of a PDCCH or a PDSCH. For example, a DL related DCI (e.g., DCI format 10, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment. For another example, an UL related DCI (e.g., DCI format 00, DCI format 01, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant. Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state can be used at least for UE-dedicated DL channels; and (3) in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources. Details of the unified TCI framework considered here can be according to those specified/described herein in the present disclosure.

In one embodiment, various unified TCI state/beam indication methods for a single-DCI (sDCI) based multi-TRP system are provided.

As discussed above, in a single-DCI (sDCI) based multi-TRP system, a UE could be provided by the network, e.g., via MAC CE or DCI (e.g., DCI format 1_1 or 1_2 with or without DL assignment) based signaling through the higher layer parameter TCI-State_r17, M>1 joint DL and UL Rel. 17 unified TCI states or M>1 separate UL Rel. 17 unified TCI states or a first combination of M>1 joint DL and UL Rel. 17 unified TCI states and separate UL Rel. 17 unified TCI states or N>1 separate DL Rel. 17 unified TCI states or a second combination of N>1 joint DL and UL Rel. 17 unified TCI states and separate DL Rel. 17 unified TCI states or a third combination of N>1 joint DL and UL Rel. 17 unified TCI states, separate DL Rel. 17 unified TCI states and separate UL Rel. 17 unified TCI for UE-dedicated reception on PDSCH/PDCCH or dynamic-grant/configured-grant based PUSCH and all of dedicated PUCCH resources.

For instance, the DCI format for unified TCI state/beam indication (e.g., DCI format 1_1 or 1_2 with or without DL assignment) could include a “transmission configuration indication” field containing one or more codepoints activated by a first MAC CE activation command from a set/pool of codepoints. For this case, each codepoint could indicate M>1 joint DL and UL Rel. 17 unified TCI states or M>1 separate UL Rel. 17 unified TCI states or a first combination of M>1 joint DL and UL Rel. 17 unified TCI states and separate UL Rel. 17 unified TCI states or N>1 separate DL Rel. 17 unified TCI states or a second combination of N>1 joint DL and UL Rel. 17 unified TCI states and separate DL Rel. 17 unified TCI states or a third combination of N>1 joint DL and UL Rel. 17 unified TCI states, separate DL Rel. 17 unified TCI states and separate UL Rel. 17 unified TCI for UE-dedicated reception on PDSCH/PDCCH or dynamic-grant/configured-grant based PUSCH and all of dedicated PUCCH resources.

Throughout the present disclosure, a Rel. 17 unified TCI state can also be referred to as a TCI state or a unified TCI state corresponding to a joint DL/UL TCI state or a DL TCI state provided by DLorJointTCI-State/TCI-State or a UL TCI state provided by UL-TCIState/TCI-State.

In a single-DCI (sDCI) based multi-TRP system, a UE could receive PDCCHs only in sDCI CORESETs, which could be determined according to at least one of following examples.

In one example, CORESETs not associated with any CORESETPoolIndex values are sDCI CORESETs. For instance, the UE is not provided by the higher layer parameter PDCCH-Config in ControlResourceSet any CORESETPoolIndex values. In this case, all CORESETs could be sDCI CORESETs.

In another example, the UE could be provided by the higher layer parameter PDCCH-Config that contains multiple (e.g., two) values of CORESETPoolIndex (e.g., 0 and 1) in ControlResourceSet. For this case, the sDCI CORESETs (provided by the higher layer parameter ControlResourceSet) are associated with a specific CORESETPoolIndex value (e.g., 0 or 1).

In yet another example, the UE could be provided by the higher layer parameter PDCCH-Config that contains a single value of CORESETPoolIndex (e.g., 0 or 1) in ControlResourceSet. For this case, the sDCI CORESETs (provided by the higher layer parameter ControlResourceSet) are associated with the provided CORESETPoolIndex value (e.g., 0 or 1).

In yet another example, the UE is not provided by the higher layer parameter PDCCH-Config in ControlResourceSet any CORESETPoolIndex values. For this case, the UE assumes CORESETPoolIndex value 0 for all CORESETs. The sDCI CORESETs (provided by the higher layer parameter ControlResourceSet) are associated with the CORESETPoolIndex value 0.

Furthermore, one or more CORESETs in the sDCI based multi-TRP system could be configured with a same group index, denoted by CORESETGroupIndex. The CORESETs configured with the same CORESETGroupIndex value could be associated with the same TRP in a multi-TRP system. The UE could be provided by PDCCH-Config one or more (e.g., two) CORESETGroupIndex values (e.g., 0 and/or 1). The association of a CORESET and a CORESETGroupIndex value could be via indicating the explicit CORESETGroupIndex value (e.g., either 0 or 1) in the parameter, e.g., the higher layer parameter ControlResourceSet, configuring the CORESET.

For this case, the sDCI CORESETs could be determined according to at least one of following examples.

In one example, CORESETs not associated with any CORESETGroupIndex values are sDCI CORESETs. For instance, the UE is not provided by the higher layer parameter PDCCH-Config in ControlResourceSet any CORESETGroupIndex values. In this case, all CORESETs could be sDCI CORESETs.

In another example, the UE could be provided by the higher layer parameter PDCCH-Config that contains multiple (e.g., two) values of CORESETGroupIndex (e.g., 0 and 1) in ControlResourceSet. For this case, the sDCI CORESETs (provided by the higher layer parameter ControlResourceSet) are associated with a specific CORESETGroupIndex value (e.g., 0 or 1).

In yet another example, the UE could be provided by the higher layer parameter PDCCH-Config that contains a single value of CORESETGroupIndex (e.g., 0 or 1) in ControlResourceSet. For this case, the sDCI CORESETs (provided by the higher layer parameter ControlResourceSet) are associated with the provided CORESETGroupIndex value (e.g., 0 or 1).

In yet another example, the UE is not provided by the higher layer parameter PDCCH-Config in ControlResourceSet any CORESETGroupIndex values. For this case, the UE assumes CORESETGroupIndex value 0 for all CORESETs. The sDCI CORESETs (provided by the higher layer parameter ControlResourceSet) are associated with the CORESETGroupIndex value 0.

In addition to the above discussed design examples, a CORESET, in which a DCI format scheduling more than one PDSCHs whose DM-RS antenna ports are quasi co-located with reference signals provided in different TCI states are received, could be a sDCI CORESET.

Furthermore, DM-RS antenna ports for PDCCH receptions in one or more sDCI CORESETs could be quasi co-located with reference signal(s) provided in an indicated reference Rel. 17 unified TCI state—e.g., one out of the indicated M>1 joint DL and UL TCI states or M>1 separate UL TCI states or N>1 separate DL TCI states. In the present disclosure, the sDCI CORESETs whose QCL assumption(s) follow that provided in the reference Rel. 17 unified TCI state or sharing the reference Rel. 17 unified TCI state is referred to as Type-1 sDCI CORESET(s), while the sDCI CORESET(s) whose QCL assumption(s) does not follow that provided in the reference Rel. 17 unified TCI state or not sharing the reference Rel. 17 unified TCI state is referred to as Type-2 sDCI CORESET(s).

Furthermore, a Type-1 sDCI CORESET or a Type-2 sDCI CORESET could correspond to one or more of: (1) “CORESET A”: a CORESET other than CORESET with index 0 (or CORESET #0) associated with only UE-dedicated PDCCH reception(s) in a CC, comprising, e.g., CORESET(s) associated with USS set(s) or Type3-PDCCH CSS set(s); (2) “CORESET B”: a CORESET other than CORESET #0 associated with only non-UE-dedicated PDCCH reception(s) in a CC, comprising, e.g., CORESET(s) associated with all types of CSS sets such as Type0/0A/1/2/3-PDCCH CSS sets or CSS sets other than Type3-PDCCH CSS set(s) such as Type0/0A/1/2-PDCCH CSS sets; (3) “CORESET C”: a CORESET other than CORESET #0 associated with both UE-dedicated and non-UE-dedicated PDCCH receptions in a CC; and/or (4) CORESET #0, i.e., CORESET with index 0.

The UE could be provided/configured with “useIndicatedR17TCIState” for one or more of the Type-1 sDCI CORESETs. For instance, the UE could be provided/configured with “useIndicatedR17TCIstate” set to “enabled” in the parameter, e.g., the higher layer parameter ControlResourceSet, that configures the corresponding Type-1 sDCI CORESET(s).

In the present disclosure, in the single-DCI based multi-TRP system, the indicated Rel. 17 unified TCI state n or m (n∈{1, . . . , N} and m∈{1, . . . , M}) could correspond to the n-th joint DL and UL TCI state or the m-th separate UL TCI state or the n-th separate DL TCI state or the m-th TCI state in the first combination of TCI states or the n-th TCI state in the second combination of TCI states or the n-th TCI state in the third combination of TCI states or the joint DL and UL TCI state with the n-th lowest or highest TCI state ID or the separate UL TCI state with the m-th lowest or highest TCI state ID or the separate DL TCI state with the n-th lowest or highest TCI state ID or the TCI state in the first combination of TCI states with the m-th lowest or highest TCI state ID or the TCI state in the second combination of TCI states with the n-th lowest or highest TCI state ID or the TCI state in the third combination of TCI states with the n-th lowest or highest TCI state ID, among the N>1 or M>1 Rel. 17 unified TCI states, indicated via the MAC CE or DCI (e.g., DCI format 1_1 or 1_2 with or without DL assignment) based signaling.

For sDCI based multi-TRP operation, DM-RS antenna ports for PDCCH receptions in the same or different sDCI CORESETs could be quasi co-located with reference signals provided in the indicated reference Rel. 17 unified TCI state. Throughout the present disclosure, a reference Rel. 17 unified TCI state can also be referred to as a reference TCI state or a reference unified TCI state corresponding to a joint DL/UL TCI state or a DL TCI state provided by DLorJointTCI-State/TCI-State or a UL TCI state provided by UL-TCIState/TCI-State. When a UE receives from the network M>1 or N>1 Rel. 17 unified TCI states indicated by a codepoint in a DCI (e.g., DCI format 1_1 or 1_2 with or without DL assignment) or MAC CE, the reference Rel. 17 unified TCI state for the sDCI CORESET(s) could be determined according to at least one of following examples.

In one example, DM-RS antenna ports for PDCCH receptions in the same or different sDCI CORESETs or Type-1 sDCI CORESETs could be quasi co-located with reference signals provided in the reference Rel. 17 unified TCI state, which could correspond to at least one of: (i) the first indicated Rel. 17 unified TCI state, (ii) the last indicated Rel. 17 unified TCI state, (iii) the indicated Rel. 17 unified TCI state with the lowest TCI state ID/index, or (iv) the indicated Rel. 17 unified TCI state with the highest TCI state ID/index, among the N>1 (or M>1) Rel. 17 unified TCI states indicated by a codepoint in a DCI (e.g., DCI format 1_1 or 1_2 with or without DL assignment) or MAC CE.

In another example, DM-RS antenna ports for PDCCH receptions in the same or different sDCI CORESETs or Type-1 sDCI CORESETs could be quasi co-located with reference signals provided in the reference Rel. 17 unified TCI state, which could correspond to the indicated Rel. 17 unified TCI state n or m, where n∈{1, . . . , N} and m∈{1, . . . , M}. For example, the UE could be higher layer configured by the network, e.g., via higher layer RRC signaling, TCI state index/ID corresponding to the Rel. 17 unified TCI state n (or m) among the N>1 (or M>1) Rel. 17 unified TCI states indicated by a codepoint in a DCI or MAC CE. For another example, the RRC configuration could contain/include a bitmap of length N (or M) with each bit/bit position in the bitmap corresponding to an indicated Rel. 17 unified TCI state; for this case, the UE could receive from the network the bitmap with the n-th (or m-th) bit/bit position set to “1.”

Yet for another example, for N=2 or M=2, the RRC configuration could contain/correspond to a one-bit flag indicator with “0” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the first indicated Rel. 17 unified TCI state or the indicated Rel. 17 unified TCI state with the lowest (or highest) TCI state ID/index, and “1” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the second indicated Rel. 17 unified TCI state or the indicated Rel. 17 unified TCI state with the highest (or lowest) TCI state ID/index, or vice versa.

In yet another example, DM-RS antenna ports for PDCCH receptions in the same or different sDCI CORESETs or Type-1 sDCI CORESETs could be quasi co-located with reference signals provided in the reference Rel. 17 unified TCI state, which could correspond to the indicated Rel. 17 unified TCI state n or m, where n∈{1, . . . , N} and m∈{1, . . . , M}. For example, the UE could receive from the network a MAC CE indicating TCI state index/ID corresponding to the Rel. 17 unified TCI state n (or m) among the N>1 (or M>1) Rel. 17 unified TCI states indicated by a codepoint in a DCI or MAC CE. For another example, the UE could receive from the network a second MAC CE activation command to activate the Rel. 17 unified TCI state n (or m) from the N>1 (or M>1) Rel. 17 unified TCI states indicated by a codepoint in a DCI or MAC CE.

For example, the second MAC CE activation command could correspond to a bitmap of length N (or M) with each bit/bit position in the bitmap corresponding to an indicated Rel. 17 unified TCI state. For this case, the UE could receive from the network the bitmap with the n-th (or m-th) bit/bit position set to “1.” Yet for another example, for N=2 or M=2, the second MAC CE activation command could contain/correspond to a one-bit flag indicator with “0” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the first indicated Rel. 17 unified TCI state or the indicated Rel. 17 unified TCI state with the lowest (or highest) TCI state ID/index, and “1” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the second indicated Rel. 17 unified TCI state or the indicated Rel. 17 unified TCI state with the highest (or lowest) TCI state ID/index, or vice versa. The second MAC CE activation command could be the same as the first MAC CE activation command used for activating one or more codepoints from a set/pool of codepoints to indicate the N>1 (M>1) unified TCI states as discussed above.

In yet another example, an indicated Rel. 17 unified TCI state, e.g., the corresponding higher layer parameter TCI-State_r17, could include a “CORESET indicator” field. For example, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORESET indicator” field set to “enabled.” For another example, the “CORESET indicator” field could indicate CORESETPoolIndex value(s). For this case, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORESET indicator” field indicating value 0 of CORESETPoolIndex.

Yet for another example, the “CORESET indicator” field could correspond to a one-bit flag indicator. For this case, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORESET indicator” indicating logical “1.” Yet for another example, the “CORESET indicator” field could be an entity ID/index corresponding to PCI, TRP ID/index and etc. For this case, DM-RS antenna ports for PDCCH receptions in the same or different sDCI CORESETs or Type-1 sDCI CORESETs could be quasi co-located with reference signals provided in the reference Rel. 17 unified TCI state with the corresponding “CORE SET indicator” field indicating a designated entity ID/index—e.g., the serving cell PCI or the first TRP.

In yet another example, DM-RS antenna ports for PDCCH receptions in the same or different sDCI CORESETs or Type-1 sDCI CORESETs could be quasi co-located with reference signals provided in the reference Rel. 17 unified TCI state, which could correspond to the indicated Rel. 17 unified TCI state n or m, where n∈{1, . . . , N} and m∈{1, . . . , M}. In this example, the DCI format (e.g., DCI format 1_1 or 1_2 with or without DL assignment) could include a “CORESET indicator” field. The “CORESET indicator” field could be configured in the same DCI format indicating the N>1 or M>1 Rel. 17 unified TCI states. For example, the “CORESET indicator” field in the DCI format could indicate TCI state index/ID corresponding to the Rel. 17 unified TCI state n (or m), and therefore the reference Rel. 17 unified TCI state, among the N>1 (or M>1) indicated Rel. 17 unified TCI states.

For another example, the “CORESET indicator” field in the DCI format could correspond to a bitmap of length N (or M) with each bit/bit position in the bitmap corresponding to an indicated Rel. 17 unified TCI state. For this case, the n-th (or m-th) bit/bit position in the bitmap is set to “1.” Yet for another example, for N=2 or M=2, the “CORESET indicator” field in the DCI format could correspond to a one-bit flag indicator with “0” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the first indicated Rel. 17 unified TCI state or the indicated Rel. 17 unified TCI state with the lowest (or highest) TCI state ID/index, and “1” indicating that DM-RS antenna ports for PDCCH receptions in the same or different sDCI CORESETs or Type-1 sDCI CORESETs could be quasi co-located with reference signals provided in the reference Rel. 17 unified TCI state corresponding to the second indicated Rel. 17 unified TCI state or the indicated Rel. 17 unified TCI state with the highest (or lowest) TCI state ID/index, or vice versa.

In the present disclosure, the indicated reference Rel. 17 unified TCI state could be a joint DL and UL TCI state or a separate UL TCI state or a separate DL TCI state or a TCI state in the first combination of TCI states or a TCI state in the second combination of TCI states or a TCI state in the third combination of TCI states.

In the above described design examples, the reference unified TCI state is specified/determined/signalled for PDCCH reception—e.g., the UE could be indicated/configured/provided by the network, e.g., via a higher layer RRC parameter/signalling such as ControlResourceSet that configures a CORESET, the reference TCI state for receiving the PDCCH. The same or similar methods of determining or signalling the reference unified TCI state as described herein in the present disclosure could be applied for PDSCH reception, PUCCH transmission or PUSCH transmission. For example, the UE could be indicated/configured/provided by the network, e.g., via a new indicator field or reusing/repurposing an existing indicator field in the scheduling DCI (e.g., DCI format 10, 1_1 or 1_2), the reference TCI state for receiving the scheduled PDSCH. For another example, the UE could be indicated/configured/provided by the network, e.g., via a higher layer RRC parameter/signalling such as PUCCH-Config that configures a PUCCH resource, the reference TCI state for transmitting the PUCCH. Yet for another example, the UE could be indicated/configured/provided by the network, e.g., via a new indicator field or reusing/repurposing an existing indicator field in the scheduling DCI (e.g., DCI format 0_1 or 0_2), the reference TCI state for transmitting the scheduled PUSCH.

As discussed herein in the present disclosure, the reference unified TCI state could be in form of TCI state ID of the reference unified TCI state, index of the reference unified TCI state among all the indicated (e.g., N>1 or M>1) unified TCI states (indicated in the beam indication DCI or MAC CE as specified herein in the present disclosure), one-bit or multi-bit (e.g., 2-bit) indicator that represents the reference unified TCI state among all the indicated (e.g., N>1 or M>1) unified TCI states (indicated in the beam indication DCI or MAC CE as specified herein in the present disclosure) and/or etc., when the reference unified TCI state is signalled/indicated/provided/configured to the UE via various signalling mediums such as RRC and/or MAC CE and/or DCI for various channels/signals such as PDCCH, PDSCH, PUCCH and/or PUSCH. For instance, when/if the reference unified TCI state is signalled/represented via a 2-bit indicator, both of the indicated TCI states (i.e., N=2 or M=2) could be used/applied for (simultaneous) reception of PDCCH, reception of PDSCH, transmission of PUCCH and/or transmission of PUSCH.

Furthermore (e.g., in one beam indication instance), the (exact) reference unified TCI state—e.g., the TCI state ID of the reference unified TCI state—could be common for all channels/signals such as PDCCH, PDSCH, PUCCH and PUSCH, or different for one or more of the DL/UL channels/signals such as PDCCH, PDSCH, PUCCH and/or PUSCH. For PDCCH reception (e.g., in one beam indication instance), the (exact) reference unified TCI state—e.g., the TCI state ID of the reference unified TCI state—could be common for all sDCI CORESETs as specified herein in the present disclosure, or different for one or more of the sDCI CORESETs as specified herein in the present disclosure.

In one embodiment, various methods of configuring beam failure detection (BFD) RS resources, candidate RS resources for new beam identification, transmitting beam failure recovery request (BFRQ), receiving beam failure recovery response (BFRR) and resetting/updating downlink/uplink beams after receiving the BFRR in a sDCI based multi-TRP system are provided.

As discussed above, the UE could be indicated by the network, e.g., via a codepoint in the “transmission configuration indication” field in a DCI format (e.g., DCI format 1_1 or 1_2 with or without DL assignment), M>1 or N>1 Rel. 17 unified TCI states. Furthermore, for the sDCI based multi-TRP system considered in the present disclosure, the QCL assumption(s) for the sDCI CORESET(s) or the Type-1 sDCI CORESET(s) could follow the QCL source RS(s) and the corresponding QCL type(s) indicated in the reference Rel. 17 unified TCI state. The determination of the reference Rel. 17 unified TCI state from the M>1 or N>1 indicated Rel. 17 unified TCI states could follow those specified in example provided in the present disclosure.

Both implicit and explicit BFD RS resource configuration methods are specified for the sDCI CORESET(s) or the Type-1 sDCI CORESET(s) under the Rel. 17 unified TCI framework.

In one embodiment, various implicit BFD RS configuration/determination methods for (Type-1) sDCI CORESET(s) under Rel. 17 unified TCI framework are provided.

A UE could implicitly determine a set of RSs (or RS resources) q0_sdci for beam failure detection for the sDCI CORESET(s) or the Type-1 sDCI CORESET(s) discussed above under the Rel. 17 unified TCI framework.

In one example, the UE could determine the BFD RS set q0_sdci to include periodic CSI-RS resource configuration indexes or SSB indexes (also referred to as BFD RS resource indexes) with same values as the RS indexes in the RS sets in the reference Rel. 17 unified TCI state indicated for respective sDCI CORESETs that the UE uses for monitoring PDCCH, wherein the indicated reference Rel. 17 unified TCI state could be determined according to those specified in examples provided in the present disclosure. For this case, the UE could monitor radio link quality of the BFD RS set q0_sdci to detect potential beam failure(s) for one or more sDCI CORESETs that the UE uses for monitoring PDCCH in the sDCI based multi-TRP system.

In another example, the UE could determine the BFD RS set q0_sdci to include periodic CSI-RS resource configuration indexes or SSB indexes (also referred to as BFD RS resource indexes) with same values as the RS indexes in the RS sets in the reference Rel. 17 unified TCI state indicated for respective Type-1 sDCI CORESETs that the UE uses for monitoring PDCCH, wherein the indicated reference Rel. 17 unified TCI state could be determined according to those specified in examples provided in the present disclosure. For this case, the UE could monitor radio link quality of the BFD RS set q0_sdci to detect potential beam failure(s) for one or more Type-1 sDCI CORESETs that the UE uses for monitoring PDCCH in the sDCI based multi-TRP system.

In one embodiment, various explicit BFD RS configuration methods for (Type-1) sDCI CORESET(s) under Rel. 17 unified TCI framework are provided.

The UE could be configured by the network a set of RSs (or RS resources) for beam failure detection (also referred to as BFD RS set) q0 under the Rel. 17 unified TCI framework. To detect potential beam failure for the sDCI CORESET(s) or the Type-1 sDCI CORESET(s) discussed above.

In one example, the UE could be configured by the network, e.g., provided by the higher layer parameter failureDetectionResourcesToAddModList, the BFD RS set q0 of periodic CSI-RS resource configuration indexes or SSB indexes for beam/link failure detection or declaration. The UE could only assess a first radio link quality of the BFD RS set q0 according to SSBs on the PCell or the PSCell or periodic CSI-RS resource configurations that are in the reference Rel. 17 unified TCI state indicated for respective sDCI CORESETs that the UE uses for monitoring PDCCH, wherein the indicated reference Rel. 17 unified TCI state could be determined according to those specified in examples provided in the present disclosure. For this case, the UE could use the first radio link quality of the BFD RS set q0 to detect potential beam failure(s) for one or more sDCI CORESETs that the UE uses for monitoring PDCCH in the sDCI based multi-TRP system.

In another example, the UE could be configured by the network, e.g., provided by the higher layer parameter failureDetectionResourcesToAddModList, the BFD RS set q0 of periodic CSI-RS resource configuration indexes or SSB indexes for beam/link failure detection or declaration. The UE could only assess a first radio link quality of the BFD RS set q0 according to SSBs on the PCell or the PSCell or periodic CSI-RS resource configurations that are in the reference Rel. 17 unified TCI state indicated for respective Type-1 sDCI CORESETs that the UE uses for monitoring PDCCH, wherein the indicated reference Rel. 17 unified TCI state could be determined according to those specified in examples provided in the present disclosure. For this case, the UE could use the first radio link quality of the BFD RS set q0 to detect potential beam failure(s) for one or more Type-1 sDCI CORESETs that the UE uses for monitoring PDCCH in the sDCI based multi-TRP system.

As for PDCCH reception (e.g., in one beam indication instance), the (exact) reference unified TCI state—e.g., the TCI state ID of the reference unified TCI state—could be common for all sDCI CORESETs as specified herein in the present disclosure or different for one or more of the sDCI CORESETs as specified herein in the present disclosure, a common BFD RS set (e.g., q0_sdci) or different/separate BFD RS sets (e.g., different q0_sdci's) could be determined for one or more of the (Type-1) sDCI CORESETs as described herein in the present disclosure to detect potential beam failure for the corresponding (Type-1) sDCI CORESETs.

In one embodiment, various BFD RS monitoring methods for (Type-1) sDCI CORESET(s) under Rel. 17 unified TCI framework are provided.

In one example, the UE could assess the radio link quality of one or more SSB indexes on the PCell or the PSCell or periodic CSI-RS resource configuration indexes in the BFD RS set q0_sdci configured for the sDCI CORESET(s) or the Type-1 sDCI CORESET(s) against a BFD threshold Qout. Furthermore, the physical layer in the UE provides an indication to higher layers when the radio link quality for all corresponding periodic CSI-RS resource configuration indexes or SSB indexes in the BFD RS set q0_sdci is worse than the threshold Qout. The physical layer informs the higher layers when the radio link quality is worse than the BFD threshold Qout a periodicity determined by the maximum between the shortest periodicity among the SSBs on the PCell or the PSCell and/or the periodic CSI-RS configurations in the BFD RS set q0_sdci and 2 msec.

In one example, the UE could assess the first radio link quality of one or more SSB indexes on the PCell or the PSCell or periodic CSI-RS resource configuration indexes in the BFD RS set q0 with same values as the RS indexes in the RS sets indicated in the reference Rel. 17 unified TCI state for respective sDCI CORESETs or Type-1 sDCI CORESET(s) that the UE uses for monitoring PDCCH in the sDCI based multi-TRP system against the BFD threshold Qout, wherein the indicated reference Rel. 17 unified TCI state could be determined according to those specified in the examples provided in the present disclosure.

The physical layer in the UE provides an indication to higher layers when the first radio link quality for all corresponding periodic CSI-RS resource configuration indexes or SSB indexes in the BFD RS set q0 that have same values as the RS indexes in the RS sets indicated in the reference Rel. 17 unified TCI state for respective sDCI CORESETs or Type-1 sDCI CORESET(s) that the UE uses for monitoring PDCCH in the sDCI based multi-TRP system is worse than the threshold Qout. The physical layer informs the higher layers when the first radio link quality is worse than the BFD threshold Qout a periodicity determined by the maximum between the shortest periodicity among the SSBs on the PCell or the PSCell and/or the periodic CSI-RS configurations in the BFD RS set q0 that the UE uses to assess the first radio link quality and 2 msec.

As a common BFD RS set (e.g., q0_sdci) or different/separate BFD RS sets (e.g., different q0_sdci's) could be determined for one or more of the (Type-1) sDCI CORESETs as described herein in the present disclosure to detect potential beam failure for the corresponding (Type-1) sDCI CORESETs, a common BFD RS monitoring process/procedure or different/separate BFD RS monitoring processes/procedures could be used/applied for one or more of the BFD RS sets as described herein in the present disclosure.

In one embodiment, various beam failure declaration methods for (Type-1) sDCI CORESET(s) under Rel. 17 unified TCI framework are provided.

In one example, the higher layers in the UE may increment BFI count (by one) in a BFI counter (denoted by BFI_COUNTER_SDCI) if the higher layers receive from the physical layer in the UE that the radio link quality of the BFD RS set q0_sdci is worse than Qout. The UE may declare a DL and/or UL beam failure for the BFD RS set q0_sdci if the BFI count in the BFI counter BFI_COUNTER_SDCI for the BFD RS set q0_sdci reaches the maximum number of BFI counts (e.g., provided by the higher layer parameter maxBFIcount) before a BFD timer expires. After the higher layers in the UE declare DL and/or UL beam failure for the BFD RS set q0_sdci, the higher layers in the UE may reset the BFI count in the BFI counter BFI_COUNTER_SDCI or the BFD timer to zero. In addition, the higher layers in the UE could also reset the BFI count in the BFI counter BFI_COUNTER_SDCI or the BFD timer to zero if the UE receives a MAC CE or DCI (e.g., DCI format 1_1 or 1_2 with or without DL assignment) based signaling indicating a different reference Rel. 17 unified TCI state from the previously indicated one.

In one example, the higher layers in the UE may increment the BFI count (by one) in a BFI counter (denoted by BFI_COUNTER_SDCI) if the higher layers receive from the physical layer in the UE that the corresponding first radio link quality of the BFD RS set q0 is worse than Qout. The UE may declare a DL and/or UL beam failure for the sDCI CORESET(s) or the Type-1 sDCI CORESET(s) if the BFI count in the BFI counter BFI_COUNTER_SDCI reaches the maximum number of BFI counts (e.g., provided by the higher layer parameter maxBFIcount) before a BFD timer expires. After the higher layers in the UE declare DL and/or UL beam failure for the sDCI CORESET(s) or the Type-1 sDCI CORESET(s), the higher layers in the UE may reset the BFI count in the BFI counter BFI_COUNTER_SDCI or the BFD timer to zero. In addition, the higher layers in the UE could also reset the BFI count in the BFI counter BFI_COUNTER_SDCI or the BFD timer to zero if the UE receives a MAC CE or DCI (e.g., DCI format 1_1 or 1_2 with or without DL assignment) based signaling indicating a different reference Rel. 17 unified TCI state from the previously indicated one.

As a common BFD RS set (e.g., q0_sdci) or different/separate BFD RS sets (e.g., different q0_sdci's) could be determined for one or more of the (Type-1) sDCI CORESETs as described herein in the present disclosure to detect potential beam failure for the corresponding (Type-1) sDCI CORESETs, a common beam failure declaration process/procedure or different/separate beam failure declaration processes/procedures could be used/applied for one or more of the BFD RS sets as described herein in the present disclosure.

For the BFD RS configurations described in examples provided in the present disclosure, the UE could be configured with/provided by the network, e.g., via the higher layer parameter candidateBeamRSList, a NBI RS set q1_sdci of periodic CSI-RS resource configuration indexes or SSB indexes for radio link quality measurement. The NBI RS set q1_sdci is associated with the BFD RS set q0_sdci used for identifying potential new beam(s) to recover the failed beam(s)/link(s) for the BFD RS set q0_sdci (or the corresponding sDCI CORESET(s) or the Type-1 sDCI CORESET(s)). The UE expects single-port or two-port CSI-RS with frequency density equal to 1 or 3 REs per RB in the set q1_sdci. The UE could assess the radio link quality according to the set q1_sdci of resource configurations against a threshold Qin.

The UE may apply the Qin threshold to the L1-RSRP measurement obtained from a SSB in q1_sdci, and apply the Qin threshold to the L1-RSRP measurement obtained from a CSI-RS resource in q1_sdci after scaling a respective CSI-RS reception power with a value provided by powerControlOffsetSS. According to the L1-RSRP measurements, the ULE could identify the periodic CSI-RS resource configuration index or SSB index in the NBI RS set q1_sdci, denoted by q_new_sdci, that corresponds to the largest/highest measured L1-RSRP among those larger than or equal to the Qin threshold.

For the BFD RS configurations described in examples provided in the present disclosure, the UE could be configured with/provided by the network, e.g., via the higher layer parameter candidateBeamRSList, a NBI RS set q1_sdci of periodic CSI-RS resource configuration indexes or SSB indexes for radio link quality measurement. The NBI RS set q1_sdci is associated with the indicated reference Rel. 17 unified TCI state or the one or more RSs (RS resources) in the BFD RS set q0 used for assessing the first radio link quality. The NBI RS set q1_sdci is used for identifying potential new beam(s) to recover the failed beam(s)/link(s) for the sDCI CORESET(s) or the Type-1 sDCI CORESET(s). The UE expects single-port or two-port CSI-RS with frequency density equal to 1 or 3 REs per RB in the set q1_sdci. The UE could assess the radio link quality according to the set q1_sdci of resource configurations against a threshold Qin.

The UE may apply the Qin threshold to the L1-RSRP measurement obtained from a SSB in q1_sdci, and apply the Qin threshold to the L1-RSRP measurement obtained from a CSI-RS resource in q1_sdci after scaling a respective CSI-RS reception power with a value provided by powerControlOffsetSS. According to the L1-RSRP measurements, the ULE could identify the periodic CSI-RS resource configuration index or SSB index in the NBI RS set q1_sdci, denoted by q_new_sdci, that corresponds to the largest/highest measured L1-RSRP among those larger than or equal to the Qin threshold.

For the BFD RS configurations described in examples provided in the present disclosure: (i) in one example, upon request from higher layers, the UE provides to higher layers the periodic CSI-RS configuration index or SSB index q_new_sdci from the NBI RS set q1_sdci and the corresponding L1-RSRP measurement that is larger than or equal to the Qin threshold, and (ii) in another example, upon request from higher layers, the UE indicates to higher layers whether there is at least one periodic CSI-RS configuration index or SSB index from the NBI RS set q1_sdci with corresponding L1-RSRP measurement that is larger than or equal to the Qin threshold, and provides the periodic CSI-RS configuration index or SSB index q_new_sdci from the NBI RS set q1_sdci and the corresponding L1-RSRP measurement that is larger than or equal to the Qin threshold, if any. Furthermore, to transmit the BFRQ for the sDCI CORESET(s) or the Type-1 sDCI CORESET(s) BFR,

In one example, the UE can be provided, by PRACH-ResourceDedicatedsDCIBFR, a configuration for PRACH transmission, wherein each periodic CSI-RS configuration index or SSB index configured in the NBI RS set q1_sdci is associated with one or more different PRACH preambles. The UE could transmit at least one PRACH preamble according to antenna port quasi co-location parameters associated with periodic CSI-RS resource configuration or with SSB associated with index q_new_sdci provided by higher layers.

In another example, the UE can be provided, by schedulingRequestID-sDCIBFR, a configuration for PUCCH transmission with a link recovery request (LRR) using either PUCCH format 0 or PUCCH format 1 as described in the 3GPP TS 38.213 clause 9.2.4. The UE could receive from the network an uplink grant in response to the PUCCH transmission with LRR for a first PUSCH MAC CE transmission. The UE could provide in the first PUSCH MAC CE indication(s) of presence of q_new_sdci for the sDCI CORESET(s) or the Type-1 sDCI CORESET(s), and index(es) q_new_sdci for a periodic CSI-RS configuration or for a SSB provided by higher layers, if any, for the sDCI CORESET(s) or the Type-1 sDCI CORESET(s).

In yet another example, the UE can be provided, by schedulingRequestID-sDCIBFR, N>1 or M>1 (e.g., N=2 or M=2) configurations for PUCCH transmission each having a link recovery request (LRR) and using either PUCCH format 0 or PUCCH format 1 as described in the 3GPP TS 38.213. Furthermore, at least one of the configurations for PUCCH transmission with a LRR (referred to as reference PUCCH configuration) is associated with the indicated reference Rel. 17 unified TCI state or the sDCI CORESET(s) or the Type-1 sDCI CORESETs.

For example, the reference PUCCH configuration could correspond to the first (or the last) configuration for PUCCH transmission having a LRR among the N>1 or M>1 configurations for PUCCH transmission. For another example, the reference PUCCH configuration could correspond to the configuration for PUCCH transmission having a LRR with the lowest (or the highest) SR ID/index value among the N>1 or M>1 configurations for PUCCH transmission. Yet for another example, the reference PUCCH configuration could correspond to the n-th (or m-th) configuration or configuration n (or m) for PUCCH transmission having a LRR or the configuration for PUCCH transmission having a LRR with the n-th (or m-th) lowest (or highest) SR ID/index value among the N>1 or M>1 configurations for PUCCH transmission.

The UE could receive from the network an uplink grant in response to one or more PUCCH transmissions with LRR (using the reference PUCCH configuration or not) for a first PUSCH MAC CE transmission. The UE could provide in the first PUSCH MAC CE indication(s) of presence of q_new_sdci for the sDCI CORESET(s) or the Type-1 sDCI CORESET(s), and index(es) q_new_sdci for a periodic CSI-RS configuration or for a SSB provided by higher layers, if any, for the sDCI CORESET(s) or the Type-1 sDCI CORESET(s).

As a common BFD RS set (e.g., q0_sdci) or different/separate BFD RS sets (e.g., different q0_sdci's) could be determined for one or more of the (Type-1) sDCI CORESETs as described herein in the present disclosure to detect potential beam failure for the corresponding (Type-1) sDCI CORESETs, a common NBI RS set (e.g., q1_sdci) or different/separate NBI RS sets (e.g., different q1_sdci's) could be determined/configured for one or more of the BFD RS sets described herein in the present disclosure—e.g., each configured NBI RS set is (one-to-one) associated to a BFD RS set.

As a common BFD RS set (e.g., q0_sdci) or different/separate BFD RS sets (e.g., different q0_sdci's) could be determined for one or more of the (Type-1) sDCI CORESETs as described herein in the present disclosure to detect potential beam failure for the corresponding (Type-1) sDCI CORESETs, a common BFRQ or different/separate BFRQs could be sent for one or more of the (failed) BFD RS sets as described herein in the present disclosure

For the sDCI based multi-TRP operation, the UE could be provided a (Type-1) sDCI CORESET through a link to a search space set provided by recoverySearchSpaceIdsDCIBFR, for monitoring PDCCH in the (Type-1) sDCI CORESET. If the UE is provided recoverySearchSpaceIdsDCIBFR, the UE does not expect to be provided another search space set for monitoring PDCCH in the (Type-1) sDCI CORESET associated with the search space set provided by recoverySearchSpaceIdsDCIBFR.

As discussed above, the UE can be provided, by PRACH-ResourceDedicatedsDCIBFR, a configuration for PRACH transmission, wherein each periodic CSI-RS configuration index or SSB index configured in the NBI RS set q1_sdci, is associated with one or more different PRACH preambles. For PRACH transmission in slot n and according to antenna port quasi co-location parameters associated with periodic CSI-RS resource configuration or with SS/PBCH block associated with index q_new_sdci from the NBI RS set q1_sdci provided by higher layers, the UE monitors PDCCH in a search space set provided by recoverySearchSpaceIdsDCIBFR for detection of a DCI format with CRC scrambled by C-RNTI or MCS-C-RNTI starting from slot n+4 within a window configured by BeamFailureRecoveryConfig.

For PDCCH monitoring in a search space set provided by recoverySearchSpaceIdsDCIBFR and for corresponding PDSCH reception, the UE assumes the same antenna port quasi-collocation parameters as the ones associated with index q_new_sdci from the NBI RS set q1_sdci until the UE receives a MAC CE or DCI (e.g., DCI format 1_1 or 1_2 with or without DL assignment) based signaling indicating a different reference Rel. 17 unified TCI state from the previously indicated one. After the UE detects a DCI format with CRC scrambled by C-RNTI or MCS-C-RNTI in the search space set provided by recoverySearchSpaceIdsDCIBFR, the UE continues to monitor PDCCH candidates in the search space set provided by recoverySearchSpaceIdsDCIBFR until the UE receives a MAC CE or DCI (e.g., DCI format 1_1 or 1_2 with or without DL assignment) based signaling indicating a different reference Rel. 17 unified TCI state from the previously indicated one.

In one example of beam resetting for the sDCI CORESET(s)—e.g., associated to the indicated reference unified TCI state as specified herein in the present disclosure—in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, after X symbols from a last symbol of a first PDCCH reception in a search space set provided by recoverySearchSpaceIdsDCIBFR where the UE detects a DCI format with CRC scrambled by C-RNTI or MCS-C-RNTI, following examples of UE operation are performed.

In one example, the UE monitors PDCCH in respective sDCI CORESETs—e.g., associated to the indicated reference unified TCI state as specified herein in the present disclosure, and/or receives PDSCH (e.g., the PDSCH scheduled by the PDCCH in the respective sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective sDCI CORESETs or the PUCCH and/or the PUSCH whose transmit filters are related to the reference signals provided in the indicated reference Rel. 17 unified TCI state) and/or SRS configured with the same indicated reference Rel. 17 unified TCI state as for the PUCCH and/or the PUSCH using a same spatial domain filter as for the last PRACH transmission, and a power setting associated with the reference Rel. 17 unified TCI state with q_u=0, q_d=q_new_sdci, and closed loop index l=0 or 1.

In such example, where X could correspond to 28, and the subcarrier spacing (SCS) for the X=28 symbols could correspond to one or more of: (1) the smallest of the SCS configurations of the active DL BWP(s) for the PDCCH reception in the respective sDCI CORESETs, and of the active DL BWP(s) of the serving cell; and/or (2) the smallest of the SCS configurations of all the signals/channels sharing the same indicated reference Rel. 17 unified TCI state.

After the UE detects a DCI format with CRC scrambled by C-RNTI or MCS-C-RNTI in the search space set provided by recoverySearchSpaceIdsDCIBFR, the UE continues to monitor PDCCH candidates in the search space set provided by recoverySearchSpaceIdsDCIBFR until the UE receives a MAC CE or DCI (e.g., DCI format 1_1 or 1_2 with or without DL assignment) based signalling indicating a different reference Rel. 17 unified TCI state from the previously indicated one.

In another example of beam resetting for the sDCI CORESET(s)—e.g., associated to the indicated reference unified TCI state as specified herein in the present disclosure—in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, if the UE provides BFR MAC CE in Msg3 or MsgA of contention based random access procedure, after X symbols from the last symbol of the PDCCH reception that determines the completion of the contention based random access procedure as described in the 3GPP TS 38.321 clause 11, following examples of the UE are performed.

In one example, the UE monitors PDCCH in respective sDCI CORESETs—e.g., associated to the indicated reference unified TCI state as specified herein in the present disclosure, and/or receives PDSCH (e.g., the PDSCH scheduled by the PDCCH in the respective sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective sDCI CORESETs or the PUCCH and/or the PUSCH whose transmit filters are related to the reference signals provided in the indicated reference Rel. 17 unified TCI state) and/or SRS configured with the same indicated reference Rel. 17 unified TCI state as for the PUCCH and/or the PUSCH using a same spatial domain filter as for the last PRACH transmission, and a power setting associated with the reference Rel. 17 unified TCI state with q_u=0, q_d=q_new_sdci, and closed loop index 1=0 or 1.

In such examples, where X could correspond to 28, and the subcarrier spacing (SCS) for the X=28 symbols could correspond to one or more of: (1) the smallest of the SCS configurations of the active DL BWP(s) for the PDCCH reception in the respective sDCI CORESETs, and of the active DL BWP(s) of the serving cell; and/or (2) the smallest of the SCS configurations of all the signals/channels sharing the same indicated reference Rel. 17 unified TCI state.

In yet another example of beam resetting for the sDCI CORESET(s)—e.g., associated to the indicated reference unified TCI state as specified herein in the present disclosure—in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, after X symbols from a last symbol of a PDCCH reception with a DCI format scheduling a PUSCH transmission with a same HARQ process number as for the transmission of the first PUSCH MAC CE and having a toggled NDI field value, following examples of the UE operations are performed.

In one example, the UE monitors PDCCH in respective sDCI CORESETs—e.g., associated to the indicated reference unified TCI state as specified herein in the present disclosure, and/or receives PDSCH (e.g., the PDSCH scheduled by the PDCCH in the respective sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective sDCI CORESETs or the PUCCH and/or the PUSCH whose transmit filters are related to the reference signals provided in the indicated reference Rel. 17 unified TCI state) and/or SRS configured with the same indicated reference Rel. 17 unified TCI state as for the PUCCH and/or the PUSCH using a same spatial domain filter as the one corresponding to q_new_sdci, and a power setting associated with the reference Rel. 17 unified TCI state with q_u=0, q_d=q_new_sdci, and closed loop index 1=0 or 1.

In such examples, where X could correspond to 28, and the subcarrier spacing (SCS) for the X=28 symbols could correspond to one or more of: (1) the smallest of the SCS configurations of the active DL BWP(s) for the PDCCH reception in the respective sDCI CORESETs, and of the active DL BWP(s) of the serving cell; and/or (2) the smallest of the SCS configurations of all the signals/channels sharing the same indicated reference Rel. 17 unified TCI state.

In yet another example of beam resetting for the sDCI CORESET(s)—e.g., associated to the indicated reference unified TCI state as specified herein in the present disclosure—in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, after X symbols from a last symbol of a PDCCH reception with a DCI format (e.g., DCI format 1_1 or 1_2 with or without DL assignment) indicating a different reference Rel. 17 unified TCI state from the previously indicated one or of a PDSCH MAC CE reception indicating a different reference Rel. 17 unified TCI state from the previously indicated one, following examples of UE operations are performed.

In one example, the UE monitors PDCCH in respective sDCI CORESETs—e.g., associated to the indicated reference unified TCI state as specified herein in the present disclosure, and/or receives PDSCH (e.g., the PDSCH scheduled by the PDCCH in the respective sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective sDCI CORESETs or the PUCCH and/or the PUSCH whose transmit filters are related to the reference signals provided in the indicated reference Rel. 17 unified TCI state) and SRS configured with the same indicated reference Rel. 17 unified TCI state as for the PUCCH and/or the PUSCH using a same spatial domain filter as the one corresponding to q_new_sdci, and a power setting associated with the reference Rel. 17 unified TCI state with q_u=0, q_d=q_new_sdci, and closed loop index 1=0 or 1.

In such examples, where X could correspond to 28, and the subcarrier spacing (SCS) for the X=28 symbols could correspond to one or more of: (1) the smallest of the SCS configurations of the active DL BWP(s) for the PDCCH reception in the respective sDCI CORESETs, and of the active DL BWP(s) of the serving cell; and/or (2) the smallest of the SCS configurations of all the signals/channels sharing the same indicated reference Rel. 17 unified TCI state.

In one example of beam resetting for the Type-1 sDCI CORESET(s)—e.g., associated to the indicated reference unified TCI state as specified herein in the present disclosure—in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, after X symbols from a last symbol of a first PDCCH reception in a search space set provided by recoverySearchSpaceIdsDCIBFR where the UE detects a DCI format with CRC scrambled by C-RNTI or MCS-C-RNTI, following examples of UE operations are performed.

In one example, the UE monitors PDCCH in respective Type-1 sDCI CORESETs—e.g., associated to the indicated reference unified TCI state as specified herein in the present disclosure, and/or receives PDSCH (e.g., the PDSCH scheduled by the PDCCH in the respective Type-1 sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective Type-1 sDCI CORESETs or the PUCCH and/or the PUSCH whose transmit filters are related to the reference signals provided in the indicated reference Rel. 17 unified TCI state) and/or SRS configured with the same indicated reference Rel. 17 unified TCI state as for the PUCCH and/or the PUSCH using a same spatial domain filter as for the last PRACH transmission, and a power setting associated with the reference Rel. 17 unified TCI state with q_u=0, q_d=q_new_sdci, and closed loop index 1=0 or 1.

In such examples, where X could correspond to 28, and the subcarrier spacing (SCS) for the X=28 symbols could correspond to one or more of: (1) the smallest of the SCS configurations of the active DL BWP(s) for the PDCCH reception in the respective Type-1 sDCI CORESETs, and of the active DL BWP(s) of the serving cell; and/or (2) the smallest of the SCS configurations of all the signals/channels—except PDCCH(s) received in sDCI CORESET(s) different from the Type-1 sDCI CORESET(s)—sharing the same indicated reference Rel. 17 unified TCI state.

After the UE detects a DCI format with CRC scrambled by C-RNTI or MCS-C-RNTI in the search space set provided by recoverySearchSpaceIdsDCIBFR, the UE continues to monitor PDCCH candidates in the search space set provided by recoverySearchSpaceIdsDCIBFR until the UE receives a MAC CE or DCI (e.g., DCI format 1_1 or 1_2 with or without DL assignment) based signalling indicating a different reference Rel. 17 unified TCI state from the previously indicated one.

In another example of beam resetting for the Type-1 sDCI CORESET(s)—e.g., associated to the indicated reference unified TCI state as specified herein in the present disclosure —in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, if the UE provides BFR MAC CE in Msg3 or MsgA of contention based random access procedure, after X symbols from the last symbol of the PDCCH reception that determines the completion of the contention based random access procedure as described in the 3GPP TS 38.321 clause 11, following examples of UE operations are performed.

In one example, the UE monitors PDCCH in respective Type-1 sDCI CORESETs—e.g., associated to the indicated reference unified TCI state as specified herein in the present disclosure, and/or receives PDSCH (e.g., the PDSCH scheduled by the PDCCH in the respective Type-1 sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective Type-1 sDCI CORESETs or the PUCCH and/or the PUSCH whose transmit filters are related to the reference signals provided in the indicated reference Rel. 17 unified TCI state) and/or SRS configured with the same indicated reference Rel. 17 unified TCI state as for the PUCCH and/or the PUSCH using a same spatial domain filter as for the last PRACH transmission, and a power setting associated with the reference Rel. 17 unified TCI state with q_u=0, q_d=q_new_sdci, and closed loop index 1=0 or 1.

In such examples, where X could correspond to 28, and the subcarrier spacing (SCS) for the X=28 symbols could correspond to one or more of: (1) the smallest of the SCS configurations of the active DL BWP(s) for the PDCCH reception in the respective Type-1 sDCI CORESETs, and of the active DL BWP(s) of the serving cell; and/or (2) the smallest of the SCS configurations of all the signals/channels—except PDCCH(s) received in sDCI CORESET(s) different from the Type-1 sDCI CORESET(s)—sharing the same indicated reference Rel. 17 unified TCI state.

In yet another example of beam resetting for the Type-1 sDCI CORESET(s)—e.g., associated to the indicated reference unified TCI state as specified herein in the present disclosure—in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, after X symbols from a last symbol of a PDCCH reception with a DCI format scheduling a PUSCH transmission with a same HARQ process number as for the transmission of the first PUSCH MAC CE and having a toggled NDI field value, following examples of UE operations are performed.

In one example, the UE monitors PDCCH in respective Type-1 sDCI CORESETs—e.g., associated to the indicated reference unified TCI state as specified herein in the present disclosure, and/or receives PDSCH (e.g., the PDSCH scheduled by the PDCCH in the respective Type-1 sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective Type-1 sDCI CORESETs or the PUCCH and/or the PUSCH whose transmit filters are related to the reference signals provided in the indicated reference Rel. 17 unified TCI state) and/or SRS configured with the same indicated reference Rel. 17 unified TCI state as for the PUCCH and/or the PUSCH using a same spatial domain filter as the one corresponding to q_new_sdci, and a power setting associated with the reference Rel. 17 unified TCI state with q_u=0, q_d=q_new_sdci, and closed loop index 1=0 or 1.

In such examples, where X could correspond to 28, and the subcarrier spacing (SCS) for the X=28 symbols could correspond to one or more of: (1) the smallest of the SCS configurations of the active DL BWP(s) for the PDCCH reception in the respective Type-1 sDCI CORESETs, and of the active DL BWP(s) of the serving cell; and/or (2) the smallest of the SCS configurations of all the signals/channels—except PDCCH(s) received in sDCI CORESET(s) different from the Type-1 sDCI CORESET(s)—sharing the same indicated reference Rel. 17 unified TCI state.

In yet another example of beam resetting for the Type-1 sDCI CORESET(s)—e.g., associated to the indicated reference unified TCI state as specified herein in the present disclosure—in a sDCI based multi-TRP system under the Rel. 17 unified TCI framework, wherein the UE could be provided in a MAC CE or DCI (e.g., DCI format 1_1 or 1_2 with or without DL assignment) M>1 or N>1 Rel. 17 unified TCI states including the reference Rel. 17 unified TCI state, after X symbols from a last symbol of a PDCCH reception with a DCI format (e.g., DCI format 1_1 or 1_2 with or without DL assignment) indicating a different reference Rel. 17 unified TCI state from the previously indicated one or of a PDSCH MAC CE reception indicating a different reference Rel. 17 unified TCI state from the previously indicated one, following examples of UE operations are performed.

In one example, the UE monitors PDCCH in respective Type-1 sDCI CORESETs—e.g. associated to the indicated reference unified TCI state as specified herein in the present disclosure, and/or receives PDSCH (e.g., the PDSCH scheduled by the PDCCH in the respective Type-1 sDCI CORESETs or the PDSCH whose DM-RS antenna ports are quasi co-located with reference signals provided in the indicated reference Rel. 17 unified TCI state) and/or aperiodic CSI-RS in a resource from a CSI-RS resource set configured with the same indicated reference Rel. 17 unified TCI state as for the PDCCH and/or PDSCH, using the same antenna port quasi co-location parameters as the ones associated with the corresponding index q_new_sdci, if any.

In one example, the UE transmits PUCCH, and/or PUSCH (e.g., the PUCCH and/or the PUSCH associated with the PDCCH in the respective Type-1 sDCI CORESETs or the PUCCH and/or the PUSCH whose transmit filters are related to the reference signals provided in the indicated reference Rel. 17 unified TCI state) and/or SRS configured with the same indicated reference Rel. 17 unified TCI state as for the PUCCH and/or the PUSCH using a same spatial domain filter as the one corresponding to q_new_sdci, and a power setting associated with the reference Rel. 17 unified TCI state with q_u=0, q_d=q_new_sdci, and closed loop index 1=0 or 1.

In such examples, where X could correspond to 28, and the subcarrier spacing (SCS) for the X=28 symbols could correspond to one or more of: (1) the smallest of the SCS configurations of the active DL BWP(s) for the PDCCH reception in the respective Type-1 sDCI CORESETs, and of the active DL BWP(s) of the serving cell and/or (2) the smallest of the SCS configurations of all the signals/channels—except PDCCH(s) received in sDCI CORESET(s) different from the Type-1 sDCI CORESET(s)—sharing the same indicated reference Rel. 17 unified TCI state.

According to the above described design examples, the UE could reset/update the receive spatial filter(s)/beam(s) for receiving the PDCCH and/or PDSCH and/or CSI-RS, and/or the transmit spatial filter(s)/beam(s) for transmitting the PUCCH and/or PUSCH and/or SRS, when/if the corresponding channels and/or signals are associated/indicated with the same reference unified TCI state as specified herein in the present disclosure.

In one embodiment, various beam measurement and reporting strategies for the multi-TRP operation under the Rel. 17 unified TCI framework are provided.

In a multi-TRP system comprising two TRPs, to support group based beam reporting or if the UE is configured with a higher layer parameter groupBasedBeamReporting-r17 set to “enabled.”

In one example, the UE could be configured with M=2 CSI resource settings provided by the higher layer parameter CSI-ResourceConfig (the number of CSI resource settings configured is limited to M=1 if the group based beam reporting for the multi-TRP operation is not supported/enabled).

In another example, the UE could be configured with S=2 CSI resource sets provided by the higher layer parameter CSI-SSB-ResourceSet or NZP-CSI-RS-ResourceSet in a CSI resource setting (the number of CSI resource sets configured in the CSI resource setting is limited to S=1 if the group based beam reporting for the multi-TRP operation is not supported/enabled).

In yet another example, the UE could be configured with K=2 CSI resource groups, e.g., provided by the higher layer parameter CSI-SSB-ResourceGroup or NZP-CSI-RS-ResourceGroup, in a CSI resource set (the number of CSI resource groups configured in the CSI resource set is limited to K=1 if the group based beam reporting for the multi-TRP operation is not supported/enabled). The two CSI resource groups include k1 and k2 SSB/NZP CSI-RS resources respectively with k1+k2=K.

If the UE receives from the network a MAC or DCI (e.g., DCI format 1_1 or 1_2 with or without DL assignment) based signaling indicating a different reference Rel. 17 unified TCI state from the previously indicated one (e.g., the UE receives from the network in a MAC CE or DCI based signaling M>1 or N>1 Rel. 17 unified TCI states with at least the reference Rel. 17 unified TCI state being different from the previously indicated one), the UE may perform radio link quality measurements (e.g., L1 measurements) on the CSI-RS or SSB resources configured in each of the two CSI resource settings (according to the example-3.1) or in each of the two CSI resource sets or in each of the two CSI resource groups.

For this case, the UE could report in a single channel state information (CSI) reporting instance N_group, if configured, group(s) of two CRIs or SSBRIs selecting one CSI-RS or SSB from each of the two CSI resource settings or from each of the two CSI resource sets or from each of the two CSI resource groups (according to the example-3.3) for the report setting, where the CSI-RS and/or SSB resources of each group can be received simultaneously by the UE. The UE could be configured/indicated by the network the number of group(s) N_group, e.g., in the corresponding CSI reporting setting via the higher layer parameter CSI-ReportConfig.

In an inter-cell system comprising the serving cell PCI and at least one PCI different from the serving cell PCI, if the UE is configured with a higher layer parameter AdditionalPCIInfo indicating necessary non-serving cell information for PCI(s) different from the serving cell PCI and the UE receives from the network in a MAC CE or DCI based signaling M>1 or N>1 Rel. 17 unified TCI states with one or more of the indicated M>1 or N>1 Rel. 17 unified TCI states being different from their corresponding previously indicated ones, the UE may perform radio link quality measurements (e.g., L1 measurements) on the CSI-RS or SSB resources configured in one or more CSI resource settings (provided by CSI-ResourceConfig) or in one or more CSI resource sets (provided by CSI-SSB-ResourceSet or NZP-CSI-RS-ResourceSet) or in one or more CSI resource groups (e.g., provided by CSI-SSB-ResourceGroup or NZP-CSI-RS-ResourceGroup), wherein the CSI-RS or SSB resources could be associated with the serving cell PCI and PCI(s) different from the serving cell PCI (or equivalently, PCI indexes referring to the serving cell PCI and PCI(s) different from the serving cell PCI within the set of PCIs configured).

For this case, the UE could report in a single CSI reporting instance N_x, if configured, CRIs or SSBRIs for each report setting, where the corresponding CSI-RS or SSB resources are associated with the serving cell PCI and PCI(s) different from the serving cell PCI (or equivalently, PCI indexes referring to the serving cell PCI and PCI(s) different from the serving cell PCI within the set of PCIs configured). The UE could be configured/indicated by the network the number of resource indicators N_x for each report setting, e.g., in the corresponding CSI reporting setting via the higher layer parameter CSI-ReportConfig. Furthermore, the non-serving cell information could include PCI(s) or PCI index(es) different from the serving cell PCI/PCI index, RS (e.g., SSB) time and frequency domain resource configurations—e.g., SSB SCS(s), SSB frequency(s), SSB positions in a burst, SSB periodicity(s)—for the PCI(s) or PCI index(es) configured therein, or RS (e.g., SSB) transmit power for the PCI(s) or PCI index(es) configured therein.

Furthermore, the UE could also be provided/configured with “useIndicatedr17TCIState” for one or more CSI-RS resources/CSI resource sets/CSI resource settings or one or more SRS resources/SRS resource sets/SRS resource settings. For this case, DM-RS antenna ports for PDCCH receptions in one or more Type-1 CORESETs in the carrier j, DM-RS antenna ports for PDSCH receptions in the carrier j, receive filter(s) for receiving one or more CSI-RS resources configured with “useIndicatedr17TCIState” in the carrier j, or transmit filter(s) for transmitting dynamic-grant/configured-grant based PUSCH, all of dedicated PUCCH resources or one or more SRS resources configured with “useIndicatedr17TCIState” in the carrier j, could be quasi co-located with or spatially related to the reference signal provided in the indicated reference Rel. 17 unified TCI state.

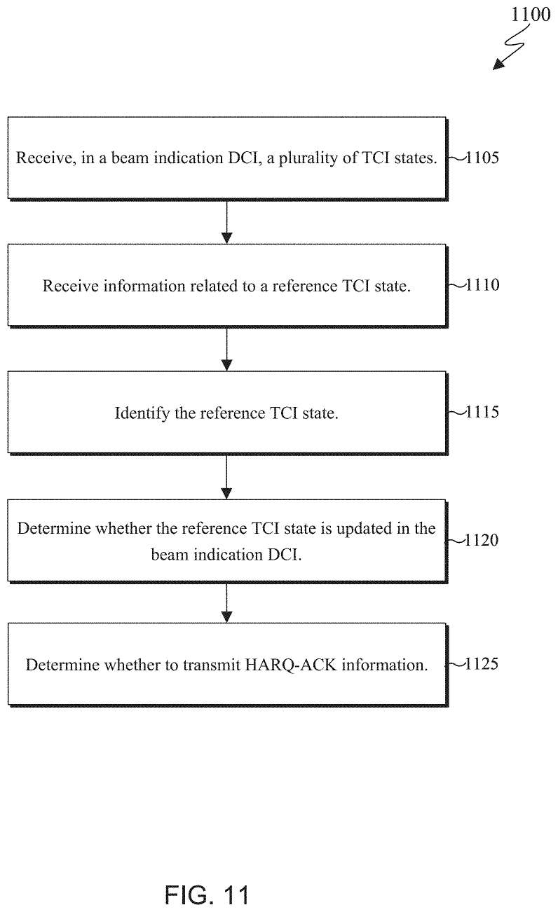

FIG. 11 illustrates an example method 1100 for receiving a beam indication by a UE in a wireless communication system according to embodiments of the present disclosure. The steps of the method 1100 of FIG. 11 can be performed by any of the UEs 111-116 of FIG. 1, such as the UE 116 of FIG. 3 and a corresponding process may be performed by a BS, such as BS 102. The method 1100 is for illustration only and other embodiments can be used without departing from the scope of the present disclosure.

The method begins with the UE receiving, in a beam indication DCI, a plurality of TCI states (step 1105). For example, the beam indication DCI may be a DCI that includes an indication of TCI states for beam indication and/or update. The UE also receives information related to a reference TCI state (step 1110). For example, the reference TCI state is one of the TCI states from among the plurality of TCI states. This information may include at least one of: (i) TCI state ID of the reference TCI state and (ii) index of the reference TCI state among the plurality of TCI states. The UE may receive this information before or after the beam indication DCI in at least one of: a higher layer signaling that configures a CORESET, a DCI that schedules a PDSCH, and a DCI that schedules a PUSCH.

The UE then identifies the reference TCI state (step 1115). For example, in step 1115, the UE may identify the reference TCI state from among the plurality of TCI states based on the information. The UE then determines whether the reference TCI state is updated in the beam indication DCI (step 1120). For example, in step 1120, the UE determines whether information of the reference TCI state has been updated since a previous beam indication DCI.

The UE then determines whether to transmit HARQ-ACK information (step 1125). For example, in step 1125, the determination is based on whether the reference TCI state was updated in the beam indication DCI and the HARQ-ACK information is an acknowledgement, to the BS, that the beam indication DCI and/or TCI state information was received. In one example, the UE may determine, based on the beam indication DCI, that the reference TCI state is not updated in the beam indication DCI and determine, based on the reference TCI state not being updated in the beam indication DCI, not to transmit the HARQ-ACK information. In another example, the UE may determine, based on the beam indication DCI, that the reference TCI state is updated in the beam indication DCI and, based on the determination that the reference TCI state is updated in the beam indication DCI, transmit, via a PUCCH, the HARQ-ACK information.

In various embodiments, if the reference TCI state is updated, the UE may determine to apply the updated reference TCI state after a first application time from the PUCCH transmission. For example, the calculation of the time to apply the updated reference TCI state may be based on the PUCCH transmission rather than the time the reference TCI state was updated, for example, via the beam indication DCI transmission or reception. In various embodiments, if the reference TCI state is not updated in the beam indication DCI while another TCI state is updated in the beam indication DCI, the UE may determine not to transmit the HARQ-ACK information and then determine to apply the updated other TCI state after a second application time from the beam indication DCI reception because there is not a HARQ-ACK transmission.

In various embodiments, the UE determines a set of BFD RSs according to reference signals indicated in the reference TCI state and monitor for a beam failure based on the determined set of BFD RSs. In another example, the UE receives a set of BFD RSs, identifies at least one of the received set of BFD RSs according to reference signals indicated in the reference TCI state, and monitors for a beam failure based on the identified one or more BFD RSs. In another example, the UE may identify one or more channels or signals that are associated with the reference TCI state and, after receiving a BFRR that is associated with the reference TCI state, determine to transmit or receive, based on a new beam, the identified one or more channels or signals that are associated with the reference TCI state.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, in a beam indication downlink control information (DCI), a plurality of transmission configuration indication (TCI) states; and
receive information related to a reference TCI state from among the plurality of TCI states; and
a processor operably coupled with the transceiver, the processor configured to:
identify, based on the information, the reference TCI state from among the plurality of TCI states;
determine whether the reference TCI state is updated in the beam indication DCI; and
determine, based on whether the reference TCI state was updated in the beam indication DCI, whether to transmit hybrid automatic repeat request acknowledgement (HARQ-ACK) information.

2. The UE of claim 1, wherein:
the information includes at least one of: (i) TCI state identity (ID) of the reference TCI state and (ii) index of the reference TCI state among the plurality of TCI states; and
the transceiver is further configured to receive the information in at least one of: a higher layer signaling that configures a control resource set (CORESET), a DCI that schedules a physical downlink shared channel (PDSCH), and a DCI that schedules a physical uplink shared channel (PUSCH).

3. The UE of claim 1, wherein the processor is further configured to:
determine, based on the beam indication DCI, that the reference TCI state is not updated in the beam indication DCI; and
determine, based on the reference TCI state not being updated in the beam indication DCI, not to transmit the HARQ-ACK information.

4. The UE of claim 1, wherein:
the processor is further configured to determine, based on the beam indication DCI, that the reference TCI state is updated in the beam indication DCI;
based on the determination that the reference TCI state is updated in the beam indication DCI, the transceiver is further configured to transmit, via a physical uplink control channel (PUCCH), the HARQ-ACK information; and
the processor is further configured to determine to apply the updated reference TCI state after a first application time from the PUCCH transmission.

5. The UE of claim 1, wherein the processor is further configured to:
determine, based on the beam indication DCI, that the reference TCI state is not updated in the beam indication DCI while another TCI state is updated in the beam indication DCI;
determine, based on the reference TCI state not being updated in the beam indication DCI, not to transmit the HARQ-ACK information; and
determine to apply the updated other TCI state after a second application time from the beam indication DCI reception.

6. The UE of claim 1, wherein the processor is further configured to:
determine a set of beam failure detection reference signals (BFD RSs) according to reference signals indicated in the reference TCI state; and
monitor for a beam failure based on the determined set of BFD RSs.

7. The UE of claim 1, wherein:
the transceiver is further configured to receive a set of beam failure detection reference signals (BFD RSs); and
the processor is further configured to:
identify one or more of the received set of BFD RSs according to reference signals indicated in the reference TCI state; and
monitor for a beam failure based on the identified one or more BFD RSs.

8. The UE of claim 1, wherein the processor is further configured to:
identify one or more channels or signals that are associated with the reference TCI state; and
after receiving a beam failure recovery request response (BFRR) that is associated with the reference TCI state, determine to transmit or receive, based on a new beam, the identified one or more channels or signals that are associated with the reference TCI state.

9. A base station (BS), comprising:
a transceiver configured to:
transmit, in a beam indication downlink control information (DCI), a plurality of transmission configuration indication (TCI) states;
transmit information related to a reference TCI state from among the plurality of TCI states; and
a processor operably coupled with the transceiver, the processor configured to:
determine whether the reference TCI state is updated in the beam indication DCI; and
determine, based on whether the reference TCI state was updated in the beam indication DCI, whether to receive hybrid automatic repeat request acknowledgement (HARQ-ACK) information.

10. The BS of claim 9, wherein:
the information includes at least one of: (i) TCI state identity (ID) of the reference TCI state and (ii) index of the reference TCI state among the plurality of TCI states; and
the transceiver is further configured to transmit the information in at least one of: a higher layer signaling that configures a control resource set (CORESET), a DCI that schedules a physical downlink shared channel (PDSCH), and a DCI that schedules a physical uplink shared channel (PUSCH).

11. The BS of claim 9, wherein the processor is further configured to:
determine that the reference TCI state is not updated in the beam indication DCI; and
determine, based on the reference TCI state not being updated in the beam indication DCI, not to receive the HARQ-ACK information.

12. The BS of claim 9, wherein:
the processor is further configured to determine that the reference TCI state is updated in the beam indication DCI;
based on the determination that the reference TCI state is updated in the beam indication DCI, the transceiver is further configured to receive, via a physical uplink control channel (PUCCH), the HARQ-ACK information; and
the updated reference TCI state is to be applied after a first application time from the PUCCH reception.

13. The BS of claim 9, wherein:
the processor is further configured to:
determine that the reference TCI state is not updated in the beam indication DCI while another TCI state is updated in the beam indication DCI, and
determine, based on the reference TCI state not being updated in the beam indication DCI, not to receive the HARQ-ACK information; and
the updated other TCI state is to be applied after a second application time from the beam indication DCI reception.

14. The BS of claim 9, wherein reference signals indicated in the reference TCI state indicate a set of beam failure detection reference signals (BFD RSs) for beam failure monitoring.

15. The BS of claim 9, wherein:
the transceiver is further configured to transmit a set of beam failure detection reference signals (BFD RSs); and
reference signals indicated in the reference TCI state indicate one or more of the set of BFD RSs for beam failure monitoring.

16. The BS of claim 9, wherein:
one or more channels or signals are associated with the reference TCI state; and
transmission of a beam failure recovery request response (BFRR) associated with the reference TCI state indicates to use a new beam for the one or more channels or signals that are associated with the reference TCI state.

17. A method for operating a user equipment (UE), the method comprising:
receiving, in a beam indication downlink control information (DCI), a plurality of transmission configuration indication (TCI) states;
receiving information related to a reference TCI state from among the plurality of TCI states;
identifying, based on the information, the reference TCI state from among the plurality of TCI states;
determining whether the reference TCI state is updated in the beam indication DCI; and
determining, based on whether the reference TCI state was updated in the beam indication DCI, whether to transmit hybrid automatic repeat request acknowledgement (HARQ-ACK) information.

18. The method of claim 17, wherein:
the information includes at least one of: (i) TCI state identity (ID) of the reference TCI state and (ii) index of the reference TCI state among the plurality of TCI states; and
receiving the information further comprises receiving the information in at least one of: a higher layer signaling that configures a control resource set (CORESET), a DCI that schedules a physical downlink shared channel (PDSCH), and a DCI that schedules a physical uplink shared channel (PUSCH).

19. The method of claim 17, wherein:
determining whether the reference TCI state is updated in the beam indication DCI further comprises determining, based on the beam indication DCI, that the reference TCI state is not updated in the beam indication DCI; and
determining whether to transmit the HARQ-ACK information further comprises determining, based on the reference TCI state not being updated in the beam indication DCI, not to transmit the HARQ-ACK information.

20. The method of claim 17, wherein determining whether the reference TCI state is updated in the beam indication DCI further comprises determining, based on the beam indication DCI, that the reference TCI state is updated in the beam indication DCI, the method further comprising:
based on the determination that the reference TCI state is updated in the beam indication DCI, transmitting, via a physical uplink control channel (PUCCH), the HARQ-ACK information; and
determining to apply the updated reference TCI state after a first application time from the PUCCH transmission.
